(19) United States
(12) Patent Application Publication
(10) Pub. No.: US 2013/0300958 A1
(43) Pub. Date: Nov. 14, 2013

(54) STEREOSCOPIC IMAGE DISPLAY APPARATUS

(71) Applicants: Kenji Matsuhiro, Tokyo (JP); Michiyuki Kohno, Tokyo (JP); Kazuhiro Sugiura, Tokyo (JP)

(72) Inventors: Kenji Matsuhiro, Tokyo (JP); Michiyuki Kohno, Tokyo (JP); Kazuhiro Sugiura, Tokyo (JP)

(73) Assignee: ARISAWA MFG. CO., LTD., Niigata (JP)

(21) Appl. No.: 13/978,924

(22) PCT Filed: Sep. 8, 2011
(86) PCT No.: PCT/JP2011/070520

§ 371 Date: Jul. 10, 2013

(30) Foreign Application Priority Data
Jan. 12, 2011 (JP) 2011-004419

(51) Int. Cl. G02B 27/22; G02F 1/13

(52) U.S. Cl. CPC G02B 27/2228; G02F 1/1313
USPC 349/15; 359/465

(57) ABSTRACT

In a display apparatus simultaneous left and right views with reduced crosstalk provide a stereoscopic image. The apparatus includes a liquid crystal display having first and second image forming areas including horizontal lines, and an optical unit in which first and second polarizing areas, corresponding to the image forming areas, are arranged. Frame images display a right eye image in the first image forming areas, and display a left eye image in the second image forming areas. The image forming areas are alternately switched or, updated every time a frame is switched. A boundary between the first and second image forming areas is moved to replace the first and second image forming areas, which display the right eye image and the left eye image. The first and second polarizing areas of the optical unit interchange phase difference states with each other.

### TECHNICAL FIELD

The present invention relates to a stereoscopic image display apparatus.

### BACKGROUND ART

Recently, flat panel televisions using flat panel displays have been actively developed. Further, as an approach for achieving a higher function, development of a stereoscopic image display apparatus using a flat panel display is being advanced.

A plurality of types of schemes is proposed for a technique using a liquid crystal display apparatus comprising a liquid crystal panel to form a stereoscopic image display apparatus. For example, a parallax barrier scheme, a lenticular lens scheme and a switch backlight scheme are known. These schemes provide an advantage in that a viewer does not need dedicated glasses to view video images from a display apparatus. However the parallax barrier scheme and the lenticular lens scheme have a problem that, the horizontal resolution is decreased and therefore the resolution of image display decreases. The switch backlight scheme has a problem in that flickering of images occurs.

As a scheme using dedicated glasses, a shutter glass scheme is known. This scheme provides an advantage of widening a display view angle of an image display apparatus without decreased resolution. However, this scheme has some problems, such as, flickering of the display images, the brightness of a display screen being decreased, and there is a time lag between images visible to the left and right eyes, therefore, natural images cannot be provided for a viewer.

In the above-mentioned technique, a stereoscopic image display apparatus is proposed which uses novel optical units to provide stereoscopic images. For example, Patent Literature 1 discloses a stereoscopic image display apparatus which does not require dedicated glasses by using two polarization filters which are such novel optical units.

With the stereoscopic image display apparatus disclosed in Patent Literature 1, a right eye polarization filter and a left eye polarization filter, having the polarization directions orthogonal to each other, are arranged in the front left and right of a light source. Further, respective lights transmitted through these filters are converted into substantially parallel lights by a Fresnel lens and radiate a liquid crystal display. Furthermore, linear polarization filter lines which are orthogonal to each other are arranged per alternating horizontal line of polarization filters on both surfaces of this liquid crystal display, and opposing linear polarization filter lines on the light source side and viewer side polarization directions which are orthogonal. Still further, the liquid crystal panel of the liquid crystal display is configured to display right eye video information and left eye video information per alternating horizontal line according to transmittance lines of two polarization filters.

That is, Patent Literature 1 discloses that all horizontal scan lines of a display screen are divided into odd lines and even lines and left eye and right eye images are displayed on respective lines to sort and display these left eye and right eye images for the left and right eyes of the viewer by means of novel optical units to display stereoscopic images.

This apparatus does not cause stereoscopic images to deteriorate even if a viewing position of a viewer is moved more or less to the left or right. Further this apparatus can avoid a phenomenon in which a horizontal resolution is decreased by half which is a problem of the parallax scheme and the lenticular lens scheme.

Further, according to Patent Literature 2, a stereoscopic image display apparatus uses novel retarders as novel optical units that have two different polarization areas, which make polarizing axes of incident lights orthogonal to each other. This stereoscopic image display apparatus has a liquid crystal display that displays a right eye image and a left eye image on different areas, and retarders corresponding to left and right image display areas, and provide stereoscopic images by projecting parallax images toward the viewer.

### CITATION LIST

### Patent Literature

[PTL 1] Japanese Patent Application Laid-Open No. Hei 10-63199
[PTL 2] Japanese Patent Application Laid-Open No. 2006-284873

### SUMMARY OF INVENTION

### Technical Problem

The stereoscopic image display apparatus using polarization filters disclosed in Patent Literature 1 however always has a fixed display position for a right eye video signal and a fixed display position for a left eye video signal on the display screen. Therefore there is a new problem in that vertical resolutions of left and right video images decrease by half.

Further, in the stereoscopic image display apparatus using the novel retarders disclosed in Patent Literature 2,

part of a right eye image of a liquid crystal display reaches the viewer's left eye through a ½ wave plate for a left eye. Therefore the Patent Literature 2 has a problem in that crosstalk, depending on the position of the viewer occurs.

Hence, the conventional stereoscopic image display apparatus is not sufficient to reduce flickers and crosstalk, maintain a high brightness in the screen and prevent a decrease in the resolution, and therefore a new stereoscopic image display apparatus is demanded.

The present invention has been made in light of the above-mentioned. That is, it is therefore an object of the present invention to provide a stereoscopic image display apparatus which reduces flickers and crosstalk, provides a high brightness in the screen and enables simultaneous viewing of left and right video images without decreasing the resolution in the screen.

Other challenges and advantages of the present invention are apparent from the following description.

### Solution to Problem

A first embodiment of the present invention is a stereoscopic image display apparatus comprising: a liquid crystal display which includes: a liquid crystal panel which is formed by arranging, in a vertical direction, horizontal lines formed by aligning pixels in a horizontal direction; and a pair of polarizing plates which sandwich the liquid crystal panel;
a backlight which is arranged on a back side of the liquid crystal display; an optical unit which is provided on a front side of the liquid crystal display; polarizing eyeglasses which a viewer wears; and
a control device which controls image display of the liquid crystal display and a phase difference state of the optical unit, wherein
the liquid crystal display includes alternately arranged first image forming areas and second image forming areas formed with the plurality of continuously provided horizontal lines of the liquid crystal panel, and is controlled by the control device such that, simultaneously, the first image forming areas display either a right eye image or a left eye image and the second image forming areas display the image not used in the first image forming area,
the first image forming areas and the second image forming areas perform one of:
(1) replacing the right eye image and the left eye image every time a frame is switched; and
(2), in a case other than (1), replacing the right eye image and the left eye image when the frame is switched and updating an image displayed in an immediate frame,
at the time when the right eye image and the left eye image are replaced, a boundary between the first image forming areas and the second image forming areas is moved, or is kept from moving,
the optical unit includes a plurality of phase difference portions corresponding to each of the plurality of horizontal lines of the liquid crystal panel, and
a first polarizing area and a second polarizing area which are formed by bundling a plurality of the phase difference portions in ranges corresponding to the first image forming areas and the second image forming areas, and include different phase difference states which are controlled by the control device in synchronization with a timing to replace the right eye image and the left eye image.

In the first embodiment of the present invention, it is preferable that the first image forming areas and the second image forming areas comprise the same area both before and after the movement of the boundary, except the uppermost and lowermost first image forming areas and second image forming areas of the liquid crystal display.

In the first embodiment of the present invention, it is preferable that a period to move the boundary between the first image forming areas and the second image forming areas is at a time when the right eye image is replaced with the left eye image and a time when the left eye image is replaced with the right eye image in the first image forming areas.

In the first embodiment of the present invention, it is preferable that following the movement of the boundary between the first image forming areas and the second image forming areas, a boundary between the first polarizing area and the second polarizing area of the optical unit also moves.

In the first embodiment of the present invention, it is preferable that the boundary between the first image forming areas and the second image forming areas is moved by one horizontal line.

In the first embodiment of the present invention, it is preferable that the first image forming areas and the second image forming areas are image forming areas each formed with two to sixty horizontal lines continuously provided in the vertical direction of the liquid crystal panel.

In the first embodiment of the present invention, it is preferable that in the optical unit, according to control by the controlling device, the first polarizing area and the second polarizing area comprise respectively different phase difference states, the different phase difference states being replaced between the first polarizing area and the second polarizing area in synchronization with a timing to replace the right eye image and the left eye image on the liquid crystal display.

In the first embodiment of the present invention, it is preferable that an entire lighting state of the backlight is controlled by the control device, according to the timing of replacing the right eye image and the left eye image.

In the first embodiment of the present invention, it is preferable that the control device sequentially controls the horizontal lines from an uppermost horizontal line to a lowermost horizontal line of the liquid crystal display to control replacement of the right eye image and the left eye image in the first image forming areas and the second image forming areas, and sequentially controls the phase difference portions from an uppermost phase difference portion to a lowermost phase difference portion of the optical unit in synchronization with the control of the liquid crystal display to control the phase difference states of the first polarizing area and the second polarizing area.

In the first embodiment of the present invention, it is preferable that the optical unit sandwiches liquid crystal between a pair of substrates comprising opposing surfaces on which transparent electrodes are disposed, and comprises phase difference films on outer surfaces of the substrates which sandwich the liquid crystal.

In the first embodiment of the present invention, it is preferable that the optical unit is formed using one liquid crystal element selected from the group consisting of a TN liquid crystal element, a homogeneous liquid crystal element and a ferroelectric liquid crystal element.

In the first embodiment of the present invention, it is preferable that a substrate forming the optical unit is formed using one film selected from the group consisting of a polycarbonate film, a triacetylcellulose film, a cycloolefin polymer film, a polyether sulfone film and a glass cloth reinforced transparent film.

In the first embodiment of the present invention, it is preferable that the liquid crystal display switches frames at a cycle of at least 120 Hz.

In the first embodiment of the present invention, it is preferable that the liquid crystal display switches frames at a cycle of at least 240 Hz.

A second embodiment of the present invention is a stereoscopic image display apparatus comprising:

a plasma display which includes: a plasma panel which is formed by arranging, in a vertical direction, horizontal lines formed by aligning pixels in a horizontal direction; and a polarizing plate which is provided on the plasma panel;

an optical unit which is provided on a front side of the plasma display;

polarizing eyeglasses which a viewer wears; and

a control device which controls image display of the plasma display and a phase difference state of the optical unit, wherein

the plasma display includes alternately arranged first image forming areas and second image forming areas formed with the plurality of continuously provided horizontal lines of the plasma panel, and is controlled by the control device such that, simultaneously, the first image forming areas display either a right eye image or a left eye image and the second image forming areas display the image not used in the first image forming area,

the first image forming areas and the second image forming areas perform one of:

(1) replacing the right eye image and the left eye image every time a frame is switched; and

(2), in a case other than (1), replacing the right eye image and the left eye image when the frame is switched and updating an image displayed in the immediately preceding frame,

at the time when the right eye image and the left eye image are replaced, a boundary between the first image forming areas and the second image forming areas is moved, or is kept from moving,

the optical unit includes a plurality of phase difference portions corresponding to each of the plurality of horizontal lines of the plasma panel, and

a first polarizing area and a second polarizing area which are formed by bundling a plurality of the phase difference portions are arranged in ranges corresponding to the first image forming areas and the second image forming areas, and include different phase difference states which are controlled by the control device in synchronization with a timing to replace the right eye image and the left eye image.

### Advantageous Effects of Invention

According to the first embodiment, the viewer can view only right eye image light with the right eye and view only left eye image light with the left eye. Consequently, the viewer can recognize these right eye image light and left eye image light as stereoscopic images.

Further, according to the first embodiment of the present invention, the stereoscopic image display apparatus can display stereoscopic images at the full resolution without decreasing the resolution in the screen. Further, right eye and left eye images are simultaneously displayed, so that it is possible to simultaneous view left eye and right eye images thus reducing fatigue of the viewer. Furthermore, it is also possible to provide the effect of canceling a sense of difference in a stereoscopic view resulting from misalignment between left and right images which occur in the case of fast moving stereoscopic images.

Further, according to the first embodiment of the present invention, it is possible to reduce crosstalk in which part of a right eye image reaches the viewer's left eye when the viewer views the vertical center of the stereoscopic image display apparatus from the position of a certain view angle. Moreover, according to the first embodiment of the present invention, it is possible to display stereoscopic images of a high brightness.

According to a second aspect of the present invention, it is possible to allow simultaneous left and right eye viewing and to realize full resolution display, and reduce crosstalk to provide a stereoscopic image display of a wide view angle and high brightness.

### BRIEF EXPLANATION OF DRAWINGS

FIG. 1 is a schematic exploded perspective view illustrating a configuration of the main parts of a stereoscopic image display apparatus according to the present embodiment.

FIG. 2 is a schematic plane view of the liquid crystal panel comprised in the stereoscopic image display apparatus according to the present embodiment.

FIG. 3 is a schematic plane view of the switching retarder comprised in the stereoscopic image display apparatus according to the present embodiment.

FIG. 4 is a schematic sectional view of the liquid crystal display portion and switching retarder portion of the stereoscopic image display apparatus according to the present embodiment.

FIG. 5 is a schematic plane view of the liquid crystal panel forming the stereoscopic image display apparatus according to the present embodiment.

FIG. 6 is a schematic plane view of the switching retarder forming the stereoscopic image display apparatus according to the present embodiment.

FIGS. 7(a) to 7(f) are views illustrating an example of image display according to the present embodiment and schematically illustrating an example of image display performed using the liquid crystal panel and the switching retarder in the first frame to the sixth frame.

FIGS. 8(a) to 8(d) are views illustrating another example of image display according to the present embodiment and schematically illustrating another example of image display performed using the liquid crystal panel and the switching retarder in the first frame to the fourth frame.

FIG. 9(a) is a view schematically illustrating an electrode structure of a conventional passive driving liquid crystal display element, and FIG. 9(b) is a view schematically illustrating an electrode structure of the switching retarder according to the present embodiment.

FIG. 10(a) is a view schematically illustrating a configuration of a conventional active driving liquid crystal display element, and FIG. 10(b) is a view schematically illustrating a configuration of main parts of the switching retarder according to the present embodiment using the active driving liquid crystal element.

FIG. 11(a) is a schematic exploded perspective view illustrating configurations of the left eye glass, and FIG. 11(b) is a schematic exploded perspective view illustrating configurations of the right eye glass.

FIG. 12(a) is a view illustrating a method of allowing the viewer recognize one frame image, and FIG. 12(b) is a view describing a method of allowing the viewer recognize a frame image after image display areas are replaced following switching of a frame.

FIGS. 13(a) and 13(b) are diagrams illustrating the configuration and function of the switching retarder according to the first example of the switching retarder in the present embodiment.

FIGS. 14(a) and 14(b) are diagrams illustrating the configuration and function of the switching retarder according to the second example of the switching retarder in the present embodiment.

FIGS. 15(a) and 15(b) are diagrams illustrating the configuration and function of the switching retarder according to the third example of the switching retarder in the present embodiment.

FIG. 16 is a view describing a display method of a conventional liquid crystal display.

FIGS. 17(a) to 17(f) are diagrams illustrating a second operational method of a stereoscopic image display apparatus.

### DESCRIPTION OF EMBODIMENTS

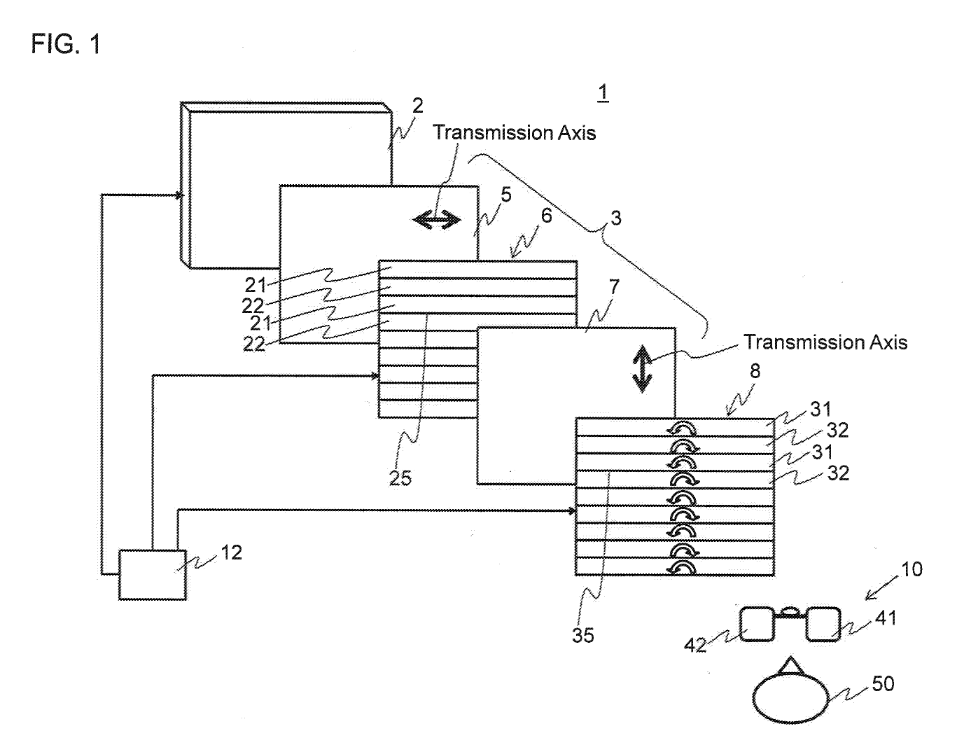

FIG. 1 is a schematic exploded perspective view illustrating a configuration of the main parts of a stereoscopic image display apparatus 1 according to the present embodiment.

As illustrated in FIG. 1, the stereoscopic image display apparatus 1 has a backlight 2, a liquid crystal display 3, and a switching retarder 8 of an optical unit, in this order. Moreover, as described later, the stereoscopic image display apparatus 1 has a control device 12 that controls the backlight 2, the liquid crystal display 3 and the switching retarder 8. These are accommodated in a housing (not illustrated). Furthermore, as illustrated in FIG. 1, the stereoscopic image display apparatus 1 has polarized glasses 10. A viewer 50 who views stereoscopic images wears these polarized glasses 10, and views images on the liquid crystal display 3 from the front surface side of the switching retarder 8. Hereinafter, main components of the stereoscopic image display apparatus 1 will be described.

The backlight 2 is arranged in the farthest side of the stereoscopic image display apparatus 1 seen from the viewer 50, and emits non-polarized white light with a uniform light amount to one surface of a polarizing plate 5 in a state where the stereoscopic image display apparatus 1 displays images (hereinafter, “the state of use of the stereoscopic image display apparatus 1”). In addition, although a planar light source is used for the backlight 2 in the present embodiment, a combination of a point light source such as LED and a condensing lens may be used instead of the planar light source. An example of this condensing lens is a Fresnel lens sheet. The Fresnel lens sheet has on one side a lens surface that coaxially has a convexity, and can convert light incident from the focus in the center of the back side into substantially parallel light and emit light toward the front surface.

As illustrated in FIG. 1, the liquid crystal display 3 is formed with a liquid crystal panel 6 sandwiched by a pair of the polarizing plate 5 and polarizing plate 7.

The polarizing plate 5 is disposed between the backlight 2 and the liquid crystal panel 6 in the liquid crystal display 3. The polarizing plate 5 has a transmission axis and an absorption axis orthogonal to the transmission axis. Hence, when non-polarized light emitted from the backlight 2 is incident on the polarizing plate 5, the polarizing plate 5 allows transmission of light of non-polarized light having the polarizing axis parallel to a transmission axis direction, and blocks light having the polarizing axis parallel to the absorption axis direction. Meanwhile, the direction of the polarizing axis refers to a vibration direction of the electric field of light. The direction of the transmission axis in the polarizing plate 5 refers to a direction parallel to the horizontal direction in which the viewer 50 faces the stereoscopic image display apparatus 1 as indicated by the arrow in FIG. 1.

Sandwiching a liquid crystal by means of, for example, glass substrates forms the liquid crystal panel 6. Electrodes that can be subjected to necessary patterning for forming pixels are provided on the side of the substrates sandwiching the liquid crystal. The electrodes are made of transparent conductive material, for example, ITO (Indium Tin Oxide). Further, it is possible to use for the liquid crystal panel 6 a liquid crystal panel of a TN (Twisted Nematic) mode, IPS (In-Plane-Switching) mode or VA (Vertical Alignment) mode. With these liquid crystal panels, the orientation of a liquid crystal changes according to the voltage to be applied. Further, the liquid crystal panel 6 is combined with the functions of the polarizing plates 5 and 7 disposed on both surfaces of the liquid crystal panel 6 to enable adjustment of the transmission light amount.

Further, the liquid crystal panel 6 is a component which forms images in the stereoscopic image display apparatus 1, and simultaneously displays a right eye image and a left eye image on one screen.

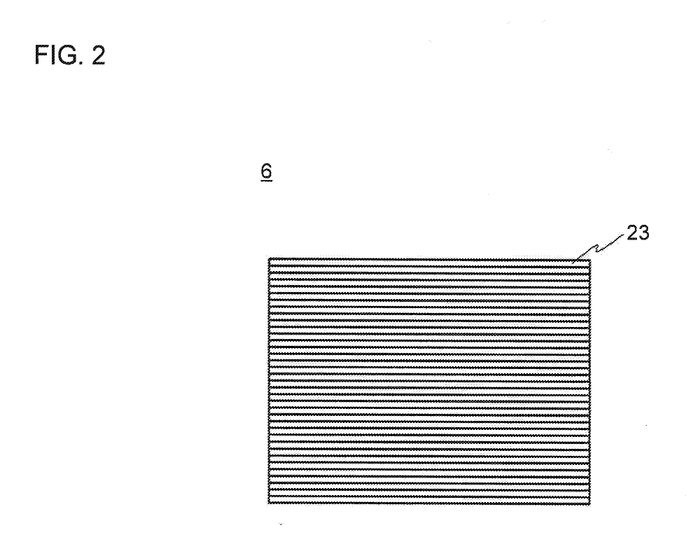

FIG. 2 is a schematic plane view of the liquid crystal panel 6 of the stereoscopic image display apparatus 1 according to the present embodiment. As illustrated in FIG. 2, the liquid crystal panel 6 is formed by arranging, in a vertical direction, a plurality of horizontal lines 23 formed by aligning pixels (not illustrated) in a horizontal direction. Hereinafter, this configuration and image display function will be described.

As illustrated in FIG. 1, the liquid crystal panel 6 has, in an image display portion, first image forming areas 21 and second image forming areas 22 partitioned in the horizontal direction by boundaries 25 when a given frame image is formed. These first image forming areas 21 and second image forming areas 22 have substantially the same area obtained by partitioning the liquid crystal panel 6 in the horizontal direction. Further, a plurality of first image forming areas 21 and second image forming areas 22 are alternately arranged in the vertical direction.

Further, the liquid crystal panel 6 of the liquid crystal display 3 of the stereoscopic image display apparatus 1 displays a right eye image and a left eye image of one frame image to be displayed, on the first image forming areas 21 and the second image forming areas 22, respectively, and replace the right eye image and the left eye image between the first image forming areas 21 and the second image forming areas 22 according to the following method of (1) or (2).

(1) The right eye image and the left eye image are replaced every time the frame is switched.

(2) In cases other than (1), the right eye image and the left eye image are replaced when the frame is switched, or an image displayed in an immediately preceding frame is overwritten (note that (2) does not include a case where the right eye image and the left eye image are maintained respectively without being replaced).

As a result, it is possible for the liquid crystal panel 6 to display a frame image in which the right eye image and the left eye image are interlaced, respectively.

For example, the stereoscopic image display apparatus 1 according to the present embodiment in particular can be formed by alternately providing the first image forming areas 21 and the second image forming areas 22 per horizontal line to correspond to all respective horizontal lines of the liquid crystal panel 6 which are used to display images.

That is, the stereoscopic image display apparatus 1 according to the present embodiment can display, for example, a right eye image in horizontal odd lines corresponding to the first image forming areas 21 of one frame image displayed on the liquid crystal panel 6 of the liquid crystal display 3. The stereoscopic image display apparatus 1 can display a left eye image in horizontal even lines corresponding to the second image forming areas 22. Further, it is possible to alternately replace horizontal lines which display the right eye image and the left eye image following switching of a frame and display a frame image in which the right eye image and the left eye image are interlaced.

The control device 12 controls driving of the liquid crystal panel 6. In addition, although not shown, an outer frame is arranged in the peripheral rim of the liquid crystal panel 6, and the first image forming areas 21 and the second image forming areas 22 in the liquid crystal panel 6 are supported by this outer frame.

As described above, in the state where the stereoscopic image display apparatus 1 is used, when one frame image is displayed, for example, a right eye image and a left eye image are generated on the first image forming areas 21 and the second image forming areas 22 of the liquid crystal panel 6. When light transmitted through the polarizing plate 5 is incident on the first image forming areas 21 and the second image forming areas 22 of the liquid crystal panel 6, transmission light of the first image forming areas 21 becomes image light for the right eye image (hereinafter abbreviated as “right eye image light”) and transmission light of the second image forming areas 22 becomes image light for the left eye image (hereinafter abbreviated as “left eye image light”). Further, in the case where the right eye image and the left eye image are replaced following switching of a frame, a left eye image and a right eye image are formed respectively on the first image forming areas 21 and the second image forming areas 22.

In addition, when one frame image is displayed as described above, right eye image light transmitted through the first image forming areas 21 and left eye image light transmitted through the second image forming areas 22 transmit through the polarizing plate 7 (described later), and become linear polarized lights having polarizing axes in respective specific directions. Meanwhile, the respective polarizing axes in respective directions may be mutually the same direction, and are the same direction as the direction of the transmission axis of the polarizing plate 7 (described later) as seen in FIG. 1.

The polarizing plate 7 is arranged on the viewer side in the liquid crystal display 3. When right eye image light transmitted through the first image forming areas 21 and left eye image light transmitted through the second image forming areas 22 in the above case are incident on the polarizing plate 7, the polarizing plate 7 allows transmission of light of these lights having the polarizing axis parallel to the transmission axis and blocks light having the polarizing axis parallel to the absorption axis (vertical to the transmission axis). As indicated by the arrow in FIG. 1, the direction of the transmission axis in the polarizing plate 7 is a direction vertical to the horizontal direction when the viewer 50 faces the stereoscopic image display apparatus 1.

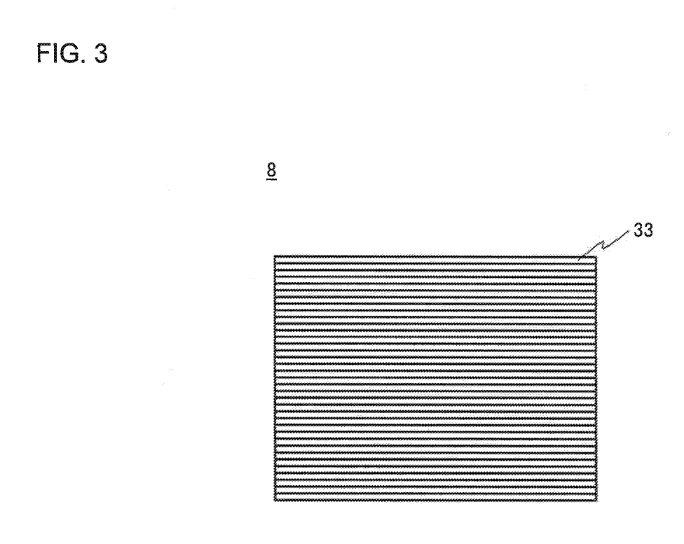

The switching retarder 8 and the liquid crystal display 3 are the principal constituent components of the stereoscopic image display apparatus 1. FIG. 3 is a schematic plane view of the switching retarder 8 of the stereoscopic image display apparatus 1 according to the present embodiment. The switching retarder 8 according to the present embodiment is formed by arranging, in a vertical direction, a plurality of phase difference portions 33 partitioned in the horizontal direction from an uppermost side to a lowermost side.

As illustrated in FIG. 3, the positions and the sizes of the phase difference portions 33 of the switching retarder 8 preferably correspond to a range of the horizontal lines 23 of the liquid crystal panel 6 in FIG. 2, that is, their positions and the sizes. Further, the switching retarder 8 according to the present embodiment is controlled by the control device 12. Furthermore, as described below, for each of the phase difference portions 33 corresponding to the horizontal lines 23 of the liquid crystal panel, control such as selection or setting of a phase difference state can be performed.

Further, as illustrated in FIG. 1, the switching retarder 8 according to the present embodiment can have first polarizing areas 31 corresponding to the first image forming areas 21, and second polarizing areas 32 corresponding to the second image forming areas 22, of the liquid crystal panel 6. The positions and the sizes of the first polarizing areas 31 and the second polarizing areas 32 of the switching retarder 8 can correspond to the a range of the first image forming areas 21 and the second image forming areas 22 of the liquid crystal panel 6, that is, their positions and sizes. The first polarizing areas 31 and the second polarizing areas 32 are partitioned in the horizontal direction by boundaries 35. Further, the switching retarder 8 is controlled by the control device 12 to perform control of switching a phase difference state per first polarizing area 31 and second polarizing area 32 in synchronization with a time period for replacing a right eye image and a left eye image between the first image forming areas 21 and the second image forming areas 22 of the liquid crystal panel 6.

Hereinafter, a structure of the switching retarder 8, which is a main component of the stereoscopic image display apparatus 1 in addition with the liquid crystal display 3, and image formation performed in combination with the liquid crystal display 3 will be described.

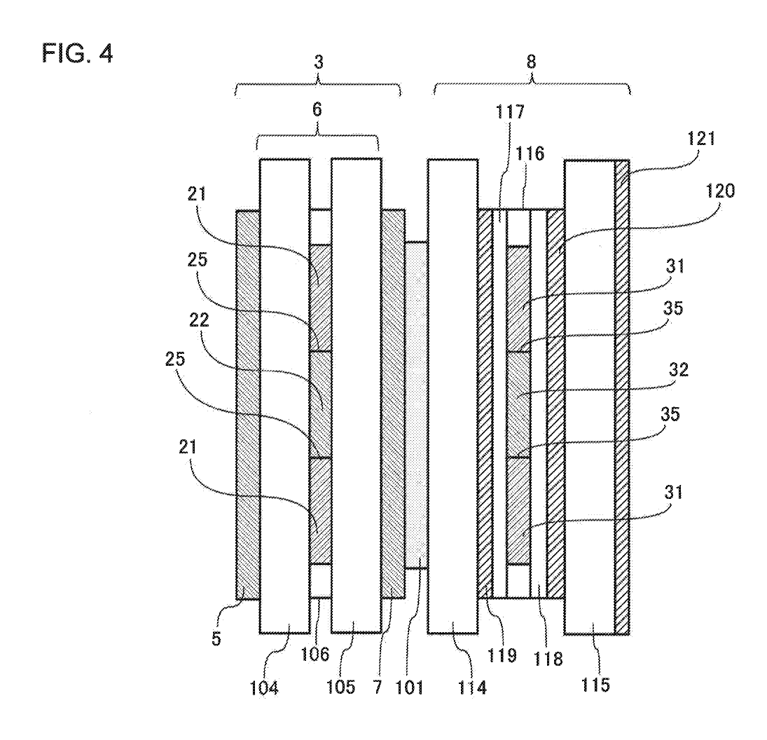

FIG. 4 is a schematic sectional view of a portion of the liquid crystal display 3 and a portion of the switching retarder 8 of the stereoscopic image display apparatus 1 according to the present embodiment.

As illustrated in FIG. 4, the liquid crystal display 3 and the switching retarder 8 of an optical unit are provided in a layered fashion in the stereoscopic image display apparatus 1. They are preferably fixed to each other by an adhesive 101 without a gap therebetween.

As described above, the liquid crystal display 3 has the liquid crystal panel 6 sandwiched by a pair of polarizing plates, that is, the polarizing plate 5 and polarizing plate 7. Sandwiching the liquid crystal 106 by a pair of substrates 104 and 105 forms this liquid crystal panel 6. Further, the above first image forming areas 21 and second image forming areas 22 are alternately arranged in this image display portion.

Furthermore, a configuration is possible where the first image forming areas 21 and the second image forming areas 22 are alternately provided to correspond to all horizontal lines 23 of the liquid crystal panel 6 for displaying images.

Further, as illustrated in FIG. 4, the switching retarder 8 has a pair of opposing substrate 114 and substrate 115. Transparent electrodes 119 and 120 made of, for example, ITO are disposed on respective opposing surfaces of the substrates 114 and 115. Oriented films 117 and 118 for orienting the liquid crystal are provided on these transparent electrodes 119 and 120. Hence, the switching retarder 8 is formed by sandwiching liquid crystal 116 by means of a pair of the substrates 114 and 115 having these transparent electrodes 119 and 120 and oriented films 117 and 118. Consequently, the switching retarder 8 can induce a change of an orientation of the liquid crystal 116 by applying the voltage to the transparent electrodes 119 and 120 on the substrates 114 and 115.

In the switching retarder 8, the transparent electrodes 119 and 120 on the substrates 114 and 115 are patterned. Further, as illustrated in FIG. 3, the phase difference portions 33 (not illustrated in FIG. 4) corresponding to the horizontal lines 23 of the liquid crystal panel 6 are formed. Consequently, as illustrated in FIG. 4, when the first image forming areas 21 and the second image forming areas 22 are set in the liquid crystal panel 6, an orientation state of the liquid crystal 116 corresponding to the first image forming areas 21 and the second image forming areas 22 can be changed. Thus, an orientation change of the liquid crystal can be induced individually according to the range of the first image forming areas 21 and the second image forming areas 22 of the liquid crystal panel 6, that is, their positions and sizes. As a result, it is possible to form the first polarizing area 31 corresponding to the first image forming areas 21, and the second polarizing areas 32 corresponding to the second image forming areas 22.

In the switching retarder 8, a phase difference film 121 is disposed on the front surface side which is the viewer 50 side. The phase difference film 121 of the switching retarder 8 forms a ¼ wave plate having the optical axis in a direction of the upper right at 45 degrees (the upper right at 45 degrees in FIG. 1) from the horizontal direction when, for example, the viewer 50 looks (faces) at the front of the liquid crystal display 3.

According to the above configuration, in the state where the stereoscopic image display apparatus 1 is used, when one frame image is displayed, right eye image light transmitted through the above-mentioned first image forming areas 21 is incident on the first polarizing areas 31. Further, left eye image light transmitted through the above-mentioned second image forming areas 22 is incident on the second polarizing areas 32. Further, in the case where image forming areas of a right eye image and a left eye image are replaced following switching of a frame, left eye image light transmitted through the first image forming areas 21 is incident on the first polarizing areas 31. Further, right eye image light transmitted through the second image forming areas 22 is incident on the second polarizing areas 32.

Moreover, according to FIG. 4, the switching retarder 8 according to the present embodiment can change the orientation of the liquid crystal 116 as described above, and change phase difference states of the first polarizing areas 31 and the second polarizing areas 32. In this case, it is possible to independently change phase difference states of the first polarizing areas 31 and the second polarizing areas 32. Consequently, when image forming areas of a right eye image and a left eye image are replaced in the liquid crystal display 3 following switching of a frame, in synchronization with this replacement, the switching retarder 8 can switch respective phase difference states of the first polarizing areas 31 and the second polarizing areas 32.

In that case, for example, the image forming areas of a right eye image and a left eye image are replaced following switching of a frame. After switching of the frame, the second polarizing areas 32 can have the phase difference state which the first polarizing areas 31 had before switching of a frame. Similarly, after switching of the frame, the first polarizing areas 31 can have the phase difference state which the second polarizing areas 32 had before switching of the frame.

Furthermore, as mentioned above, in the stereoscopic image display apparatus 1 according to the present embodiment, first image forming areas 21 and the second image forming areas 22 can be configured so as to correspond to individual horizontal lines of the image display of the liquid crystal panel 6. In this case, in the switching retarder 8, patterning of the transparent electrodes 119 and 120 is performed in the range corresponding to individual horizontal lines 23 of liquid crystal panel 6, that is, the range corresponds to position and size. Further, in the switching retarder 8, a plurality of phase difference portions 33 partitioned in the horizontal direction are arranged and formed in the vertical direction.

Therefore, first image forming areas 21 and second image forming areas 22, corresponding to individual horizontal lines 23, are formed in the liquid crystal panel 6. The first polarizing areas 31 and the second polarizing areas 32, corresponding to the first image forming areas 21 and second image forming areas 22, are formed in the switching retarder 8.

In this case, a right eye image and a left eye image are displayed respectively on the first image forming areas 21 associated with odd horizontal lines of one frame image to be displayed in the liquid crystal display and the second image forming areas 22 associated with even horizontal lines. The horizontal lines for displaying the right eye image and the left eye image are replaced alternately, when a frame is switched. The replacement of phase difference states such as the above-mentioned, is performed in synchronization with the replacement of the horizontal lines in the first polarizing area 31 and the second polarizing area 32 of the switching retarder 8, further, it is possible to display a frame image interlacing the right eye image and the left eye image respectively.

However, in the stereoscopic image display apparatus 1 according to the present embodiment, when first image forming areas 21 and the second image forming areas 22 are configured to correspond to individual horizontal lines of the image display of the liquid crystal panel 6, and the first polarizing area 31 and the second polarizing area 32 of the switching retarder 8 are configured to correspond to the first image forming areas 21 and the second image forming areas 22, there will be a problem in that crosstalk will occur.

That is, there are cases where the viewer 50 views stereoscopic images on the stereoscopic image display apparatus 1 at a view angle from the center in the vertical direction of the liquid crystal display 3 forming the screen of the stereoscopic image display apparatus 1. Originally, when one frame image is displayed, only right eye image light transmitted through the first image forming areas 21 of the above-mentioned liquid crystal panel 6 needs to be incident on the first polarizing areas 31 of the switching retarder 8. Further, only left eye image light transmitted through the second image forming areas 22 needs to be incident on the second polarizing areas 32. By contrast with this, when the lower or upper view angle is great, there are cases where part of right eye image light transmitted through the first image forming areas 21 of the liquid crystal panel 6 is incident on the second polarizing areas 32 on which only left eye image light originally needs to be incident, and reaches the left eye of the viewer 50 together with the left eye image light.

Hence, by taking into account the problem of this crosstalk, it is necessary to form the first image forming areas 21 and the second image forming areas 22 in the liquid crystal panel 6, it is further necessary to form the first polarizing areas 31 and the second polarizing areas 32 in the switching retarder 8 and thus improve the structure.

This type of crosstalk, which is a problem of the previous invention, is caused because the first polarizing areas 31 and the second polarizing areas 32 having different phase difference characteristics are provided adjacent to each other in the switching retarder 8 to correspond to the liquid crystal panel 6. That is, as described above, in the liquid crystal panel 6 of the stereoscopic image display apparatus 1 according to the present embodiment, the first image forming areas 21 and the second image forming areas 22 having the same area are sequentially provided from the top in the vertical direction. The corresponding first polarizing areas 31 and second polarizing areas 32 of the switching retarder 8 are provided to be adjacent to each other. Therefore, crosstalk is likely to occur when the viewer 50 views images on the screen at a certain view angle in the vertical direction of the screen of the stereoscopic image display apparatus 1.

This type of crosstalk occurs at boundary areas between the first polarizing areas 31 and the second polarizing areas 32 of the switching retarder 8 which are adjacent to each other. Hence, to reduce this crosstalk, it is effective to reduce the boundary areas between the adjacent first polarizing areas 31 and second polarizing areas 32 in the switching retarder 8.

For example, when the liquid crystal panel 6 has 1080 horizontal lines 23 according to the full HD (full high definition) specification, it is possible to provide the first image forming areas 21 and the second image forming areas 22 in association with each of all horizontal lines 23 respectively as described above. In this case, 540 first image forming areas 21 and 540 second image forming areas 22 are alternately provided. Further, the switching retarder 8 has 540 first polarizing areas 31 and 540 second polarizing areas 32 corresponding to the positions and sizes of the first image forming areas 21 and the second image forming areas 22 of the liquid crystal panel 6. As a result, 1079 boundary areas between the adjacent first polarizing areas 31 and second polarizing areas 32 are formed.

Further, when the viewer 50 views images on the screen of the stereoscopic image display apparatus 1 from above at a certain view angle, crosstalk occurs at each boundary area. Furthermore, the strength of crosstalk becomes the highest in the case where the first image forming areas 21 and the second image forming areas 22 are provided in association with all horizontal lines 23 respectively as described above.

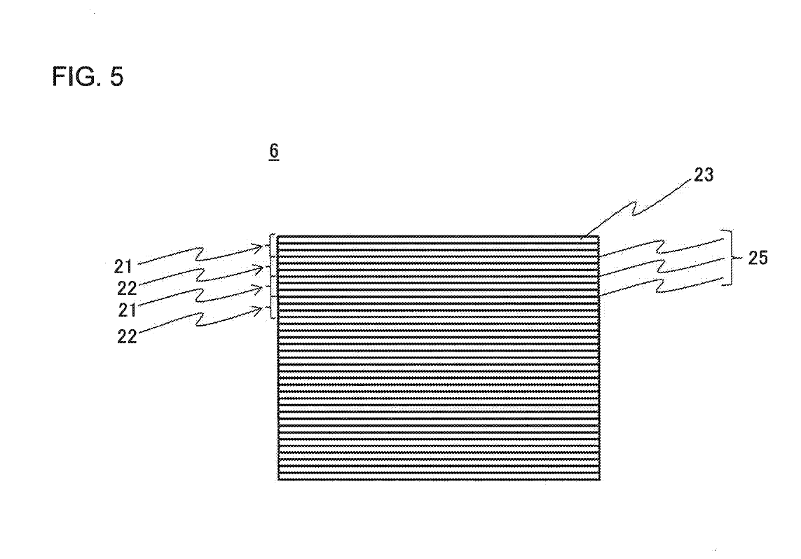

FIG. 5 is a schematic plan view of the liquid crystal panel 6 forming the stereoscopic image display apparatus 1 according to the present embodiment.

Therefore, in the liquid crystal panel 6 according to the present embodiment, the first image forming areas 21 and the second image forming areas 22 are preferably formed with a plurality of horizontal lines 23, and are preferably alternately arranged, separated by the boundary 25, as illustrated in FIG. 5.

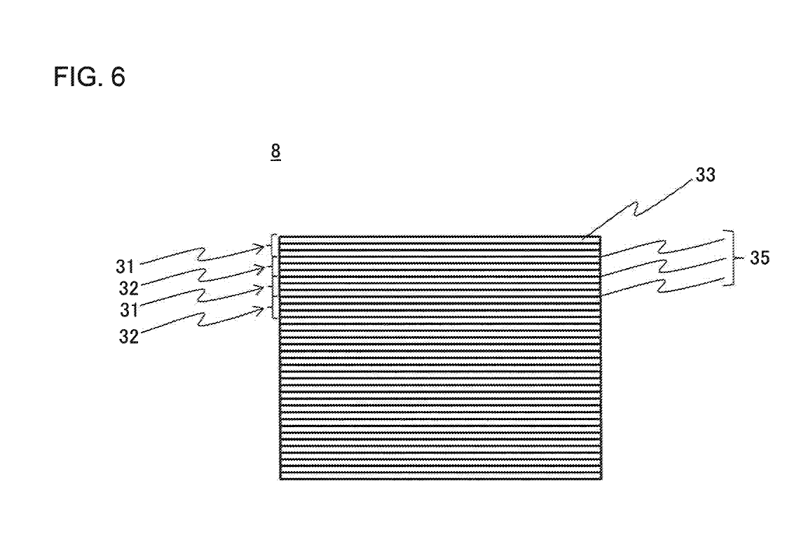

FIG. 6 is a schematic plane view of the switching retarder 8 forming the stereoscopic image display apparatus 1 according to the present embodiment.

As illustrated in FIG. 6, in the switching retarder 8 the first polarizing areas 31 and the second polarizing areas 32 are formed using a plurality of phase difference portions 33 so as to correspond to the positions and sizes of the first image forming areas 21 and the second image forming areas 22 of the liquid crystal panel 6. Therefore, these areas of the first image forming areas 21 and the second image forming areas 22 of the switching retarder 8 increase in proportion to the number of horizontal lines 23 to be bound as sets in the liquid panel 6. As a result, it is possible to reduce the boundary areas, that is, the boundary 35 between the adjacent first polarizing areas 31 and second polarizing areas 32 in the switching retarder 8.

The boundary areas between the adjacent first polarizing areas 31 and second polarizing areas 32 which cause crosstalk are reduced, so that crosstalk occurring in the stereoscopic image display apparatus 1 is reduced as a whole. Consequently, in proportion to an increase in the number of horizontal lines 23 to be bound as sets to form the first image forming areas 21 and the second image forming areas 22 of the liquid crystal panel 6, crosstalk is more suppressed and the viewer 50 is less likely to notice crosstalk.

Meanwhile, in the stereoscopic image display apparatus 1 according to the present embodiment, the number of horizontal lines 23 which form a set for forming the first image forming areas 21 and the second image forming areas 22 in the liquid crystal panel 6 in the stereoscopic image display apparatus 1, needs to be limited. When the number of horizontal lines 23 which form a set is increased and therefore the first image forming areas 21 and the second image forming areas 22 become excessively wide, there are concerns of problems that flicker occurs and, in addition, a natural image cannot be obtained for a viewer. Hence, the number of horizontal lines 23 which form a set is limited to prevent crosstalk, and the number of boundary areas between the first polarizing areas 31 and adjacent second polarizing areas 32 cannot be reduced to a certain level in the switching retarder 8.

Further, when the first image forming areas 21 and the second image forming areas 22 are formed by a plurality of horizontal lines 23 in the liquid crystal panel 6 and fixed to generate a left eye image or a right eye image, the boundary areas between the first image forming areas 21 and the second image forming areas 22 are also fixed. In this case, in the corresponding switching retarder 8, the boundary areas between the first polarizing areas 31 and the second polarizing areas 32 are also fixed and as a result crosstalk produced in these boundary areas is also fixed. As a result, while average crosstalk in the entire display screen is reduced, crosstalk produced in part of boundary areas causes unevenness in display which is to be viewed by the viewer, depending on a video image displayed on the screen.

Hence, the stereoscopic image display apparatus 1 according to the present embodiment changes the boundaries 25 between the first image forming areas 21 and the second image forming areas 22 per, for example, one display frame. In this case, areas of the first image forming areas 21 and the second image forming areas 22, that is, the numbers of horizontal lines 23 which form these, are prevented from changing between before and after movement of the boundaries 25. As a result, positions to form the first image forming areas 21 and the second image forming areas 22 are shifted according to the amount of shift of the boundaries 25 in the display screen of the liquid crystal panel 6. Further, positions to form the first polarizing areas 31 and the second polarizing areas 32 are also shifted likewise in the corresponding switching retarder 8, and the boundaries 35 are shifted according to the shifts of the boundaries 25 of the liquid crystal panel 6. Before and after movement of the boundaries 35, areas of the first polarizing areas 31 and the second polarizing areas 32 do not change.

Further, preferably, as one frame for displaying an image proceeds, the boundaries 25 between the first image forming areas 21 and the second image forming areas 22 are shifted, for example, sequentially downward or upward per horizontal line. That is, the boundaries 25 are moved per horizontal line 23 as a unit. Further, when the boundaries 25 are sequentially moved, and the shifts of the boundaries 25 reach a predetermined number of a plurality of lines, that is, the number of horizontal lines 23 which form the first image forming areas 21 and the second image forming areas 22, the boundaries 25 return to positions of a first display frame.

In this case, in the corresponding switching retarder 8, as one frame for displaying an image proceeds, the boundaries 35 between the first polarizing areas 31 and the second polarizing areas 32 are shifted sequentially per horizontal line, corresponding the shifts of the boundaries 25 between the first image forming areas 21 and the second image forming areas 22. Further, when the boundaries 35 are sequentially moved, and the shifts of the boundaries 35 reach a predetermined number of a plurality of lines, that is, the number of phase difference portions 33 which form the first polarizing areas 31 and the second polarizing areas 32, the boundaries 35 return to positions again in a first display frame.

Further, according to another configuration, the boundaries 25 between the first image forming areas 21 and the second image forming areas 22 are not sequentially shifted per horizontal line, and positions of the first image forming areas 21 and the second image forming areas 22 are changed at random. Furthermore, positions to form the first polarizing areas 31 and the second polarizing areas 32 are also changed in the switching retarder 8 accordingly. In this case, boundary areas between the first polarizing areas 31 and the second polarizing areas 32 are not also fixed, so that it is possible to provide the same effect as the above.

As described above, by moving the boundaries 25 between the first image forming areas 21 and the second image forming areas 22 without fixing the boundaries 25, it is possible to uniformly distribute positions at which crosstalk occurs, in the entire display screen. As a result, viewers can view smoother stereoscopic image display of with minimal unevenness and crosstalk, which is the original intention of this invention. Further, the stereoscopic image display apparatus 1 according to the present embodiment reduces crosstalk, thereby expanding a view angle and improving the angle-of-view characteristics.

Hereinafter, configurations of the liquid crystal display 3 and the switching retarder 8 of the stereoscopic image display apparatus 1 according to the present embodiment which reduces crosstalk as described above, and image formation according to these configurations will be described in more detail using the drawings.

As described above, as illustrated in FIG. 5, in the liquid crystal panel 6 of the stereoscopic image display apparatus 1 according to the present embodiment, the first image forming areas 21 and the second image forming areas 22 are preferably formed with a plurality of horizontal lines 23 which can be each independently controlled. Further, as a result of research into preventing the above flicker and obtaining a natural image for the viewer 50, it was found that the first image forming areas 21 and the second image forming areas 22 of the liquid crystal panel 6 are each preferably formed with two to sixty horizontal lines 23 continuously arranged in the vertical direction of the liquid crystal panel 6.

Further, in the stereoscopic image display apparatus 1, the first image forming areas 21 and the second image forming areas 22 of the liquid crystal panel 6 are more preferably formed with three to thirty horizontal lines 23 continuously aligned in the vertical direction of the liquid crystal panel 6. Furthermore, more preferably formed with five to fifteen horizontal lines 23.

In this case, as illustrated in FIG. 6, the first polarizing areas 31 and the second polarizing areas 32 are formed using a plurality of, for example, three phase difference portions 33 as one set so as to correspond to the positions and sizes of the first image forming areas 21 and the second image forming areas 22 of the liquid crystal panel 6 in the switching retarder 8. More specifically, the first polarizing areas 31 and the second polarizing areas 32 are formed with two to sixty phase difference portions 33 to have positions and sizes corresponding to the first image forming area 21 and the second image forming areas 22 of the liquid crystal panel 6. Further, the first polarizing areas 31 and the second polarizing areas 32 are formed by, preferably, three to thirty phase difference portions 33 and, most preferably, five to fifteen phase difference portions 33.

In the liquid crystal panel 6 illustrated in FIG. 5, the first image forming areas 21 and the second image forming areas 22 are each formed with, for example, three continuously aligned horizontal lines 23. In the switching retarder 8 illustrated in FIG. 6, the first polarizing areas 31 and the second polarizing areas 32 are each formed with, for example, three continuously aligned phase difference portions 33 so as to correspond the liquid crystal panel 6 in FIG. 5.

As the result, when the images are displayed in the above-mentioned one frame period in the liquid crystal panel 6, the uppermost first horizontal line to the third horizontal line in the liquid crystal panel 6 are bound as one set to form the first image forming area 21. Further, the fourth horizontal line to the sixth horizontal line are bound as one set across the boundaries 25 to form the second image forming area 22. Furthermore, the seventh horizontal line to the ninth horizontal line across the boundaries 25 are further bound to form the first image forming area 21, and the tenth horizontal line to the twelfth horizontal line are bound to form the second image forming area 22. That is, with the liquid crystal panel 6 illustrated in FIG. 5, three each of the horizontal lines 23 are sequentially bound to form one set. Further, a plurality of first image forming areas 21 and second image forming areas 22 are alternately arranged across the boundaries 25 in the liquid crystal panel 6 in association with respective sets.

When the images display in the one frame period in the switching retarder 8, the uppermost first phase difference portions to the third phase difference portions in the switching retarder 8 are bound as one set to form the first polarizing areas 31. Further, the fourth phase difference portions 33 to the sixth phase difference portions 33 are bound as one set across the boundaries 35 to form the second polarizing areas 32. Furthermore, the seventh phase difference portions to the ninth phase difference portions across the boundaries 35 are further bound to form the first polarizing areas 31, and the tenth phase difference portions to the twelfth phase difference portions are bound to form the second polarizing areas 32. That is, with the switching retarder 8 illustrated in FIG. 6, three continuously provided phase difference portions 33 are sequentially bound to form one set. Further, a plurality of first polarizing areas 31 and second polarizing areas 32 are alternately arranged, separated by the boundaries 35 in the switching retarder 8 in association with respective sets.

Meanwhile, the number of horizontal lines 23 for forming the first image forming areas 21 and the second image forming areas 22 is not limited to three illustrated in FIG. 5, and may be plural in the above-mentioned preferable range. For example, the number of horizontal lines 23 for forming the first image forming areas 21 and the second image forming areas 22 may be five or ten.

For example, when the number of horizontal lines 23 to be bound as one set is ten in the liquid crystal panel 6, the uppermost first horizontal line to the tenth horizontal line in the liquid crystal panel 6 are bound as one set to form the first image forming area 21. Further, the eleventh horizontal line to the twentieth horizontal line across the boundaries 25 are bound as one set to form the second image forming area 22. Furthermore, the twenty-first horizontal line to the thirtieth horizontal line are further bound to form the first image forming area 21, and the thirty-first horizontal line to the fortieth horizontal line are bound to form the second image forming area 22. Still further, ten each of the horizontal lines 23 are sequentially bound such that a plurality of first image forming areas 21 and second image forming areas 22 are alternately arranged across the boundaries 25 in the liquid crystal panel 6.

In this case, every ten phase difference portions 33 is also bundled sequentially in the switching retarder 8, and, pluralities of the first polarizing areas 31 and the second polarizing areas 32 are alternately arranged across the boundaries 35.

Accordingly, in the state where the stereoscopic image display apparatus 1 is used, when one frame image is displayed, right eye image light transmitted through the first image forming areas 21 in the above case is incident on the first polarizing areas 31 of the switching retarder 8. Further, left eye image light transmitted through the second image forming areas 22 in the above case is incident on the second polarizing areas 32. Furthermore, in the case where image forming areas of the right eye image and the left eye image in the liquid crystal panel 6 are replaced following switching of a frame, left eye image light transmitted through the first image forming areas 21 is incident on the first polarizing areas 31 of the switching retarder 8. Still further, right eye image light transmitted through the second image forming areas 22 is incident on the second polarizing areas 32.

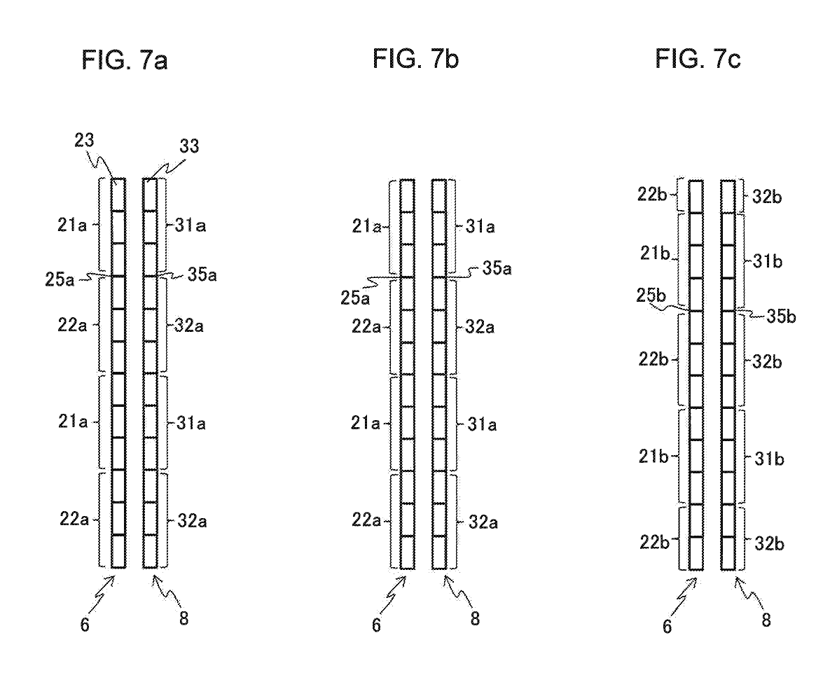

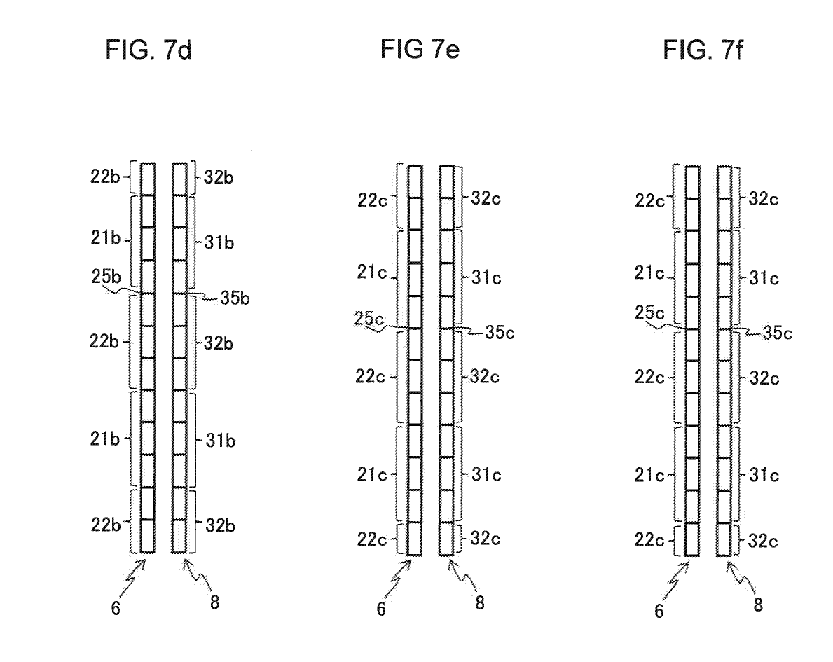

FIG. 7 is a schematic cross-sectional view explaining an example of image display performed using the liquid crystal panel 6 and the switching retarder 8 according to the present embodiment. FIGS. 7(a) to 7(f) schematically describe example of image display performed using the liquid crystal panel 6 and the switching retarder 8 in the first frame to the sixth frame.

FIGS. 7(a) to 7(f) schematically illustrate an example where, in the liquid crystal panel 6 of the liquid crystal display, first image forming areas 21a, 21b and 21c and second image forming areas 22a, 22b and 22c are each formed with the three horizontal lines 23 across boundaries 25a, 25b and 25c to correspond with FIG. 5.

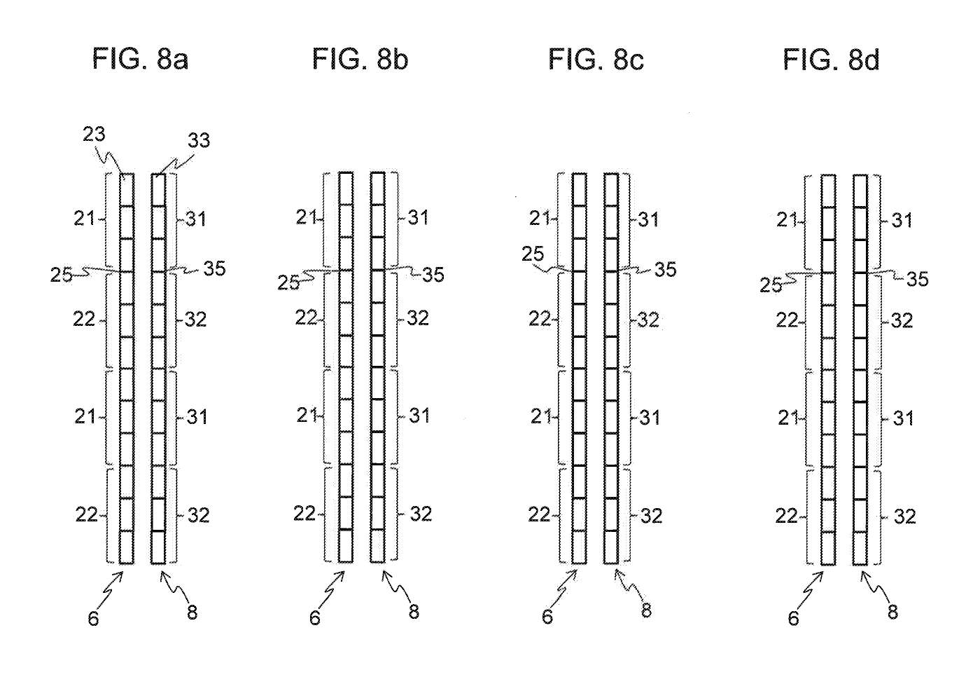

FIG. 8 is a schematic cross-sectional view explaining another example of image display performed using the liquid crystal panel 6 and the switching retarder 8 according to the present embodiment. FIGS. 8(a) to 8(d) schematically describe another example of image display performed using the liquid crystal panel 6 and the switching retarder 8 in the first frame to the fourth frame.

FIGS. 8(a) to 8(d) schematically illustrate example where, in the liquid crystal panel 6 of the liquid crystal display 3, first image forming area 21 and second image forming area 22 are each formed with the three horizontal lines 23 across boundaries 25 to correspond with FIG. 5. In the example illustrated in FIG. 8, in one frame for displaying in FIG. 8(a) (hereinafter, first frame), three each of the horizontal lines 23 are sequentially bound to form one set in the liquid crystal panel 6. Further, a plurality of first image forming areas 21 and second image forming areas 22 are alternately arranged, separated by the boundaries 25 in the liquid crystal panel 6 in association with respective sets as shown in FIGS. 8(a) to 8(d).

That is, with the switching retarder 8 illustrated in FIGS. 8(a) to 8(d), three phase difference portions 33 are sequentially bound to form one set. Further, a plurality of first polarizing areas 31 and second polarizing areas 32 are alternately arranged across the boundaries 35 in the switching retarder 8 in association with respective sets.

Hence, in a first frame, for example, right eye image light having transmitted through the first image forming areas 21 is incident on the first polarizing areas 31 of the switching retarder 8. Further, left eye image light having transmitted through the second image forming areas 22 is incident on the second polarizing areas 32. Furthermore, when image forming areas of a right eye image and a left eye image in the liquid crystal panel 6 are replaced following switching of a frame, the left eye image light having transmitted through the first image forming areas 21 is incident on the first polarizing areas 31 of the switching retarder 8 in one next display frame (also referred to as a “second frame” below) in FIG. 8(b). Still further, the right eye image light having transmitted through the second image forming areas 22 is incident on the second polarizing areas 32.

Moreover, in the next display frame (also referred to as a “third frame” below) in FIG. 8(c), image forming areas of a right eye image and a left eye image in the liquid crystal panel 6 are replaced again and the right eye image light having transmitted through the first image forming areas 21 is incident on the first polarizing areas 31 of the switching retarder 8, in the same fashion as the first frame. Still further, the left eye image light having transmitted through the second image forming areas 22 is incident on the second polarizing areas 32.

Moreover, in the subsequent display frame (also referred to as a “fourth frame” below) in FIG. 8(c), the left eye image light having transmitted through the first image forming areas 21 is incident on the first polarizing areas 31 of the switching retarder 8, in a similar fashion to the second frame. Still further, the right eye image light having transmitted through the second image forming areas 22 is incident on the second polarizing areas 32. Further, this same arrangement of light incident on specific image forming areas is also repeated in subsequent display frames.

In this case, as illustrated in FIGS. 8(a) to 8(d), the boundaries 25 between the first image forming areas 21 and the second image forming areas 22 of the liquid crystal panel 6 are at fixed positions at all times in the liquid crystal panel 6 even when the image forming areas of a right eye image and a left eye image in the liquid crystal panel 6 are replaced. The boundaries 25 are fixed in the liquid crystal panel 6 irrespectively of progress of a display frame. Similarly, the boundaries 35 between the first polarizing areas 31 and the second polarizing areas 32 of the switching retarder 8 are at fixed positions at all times in the switching retarder 8 even when the image forming areas of a right eye image and a left eye image in the liquid crystal panel 6 are replaced. The boundaries 35 are also fixed in the switching retarder 8 irrespective of a display frame. As a result, there is a concern that crosstalk will occur in areas near the boundaries 35 that are fixed, and the above unevenness in the display is viewed by viewers.

Hence, when image forming areas of a right eye image and a left eye image are replaced following switching of a frame as illustrated in FIGS. 7(a) to 7(f), the stereoscopic image display apparatus 1 according to the present embodiment changes the positions of the boundaries 25a, 25b and 25c between the first image forming areas 21a, 21b and 21c and the second image forming areas 22a, 22b and 22c of the liquid crystal panel 6.

FIGS. 7(a) to 7(f) schematically illustrate an example where, in the liquid crystal panel 6 of the liquid crystal display 3, first image forming areas 21a, 21b and 21c and second image forming areas 22a, 22b and 22c are each formed with the three horizontal lines 23 across boundaries 25a, 25b and 25c to correspond with FIG. 5.

As illustrated in FIG. 7, in one frame for displaying, as shown in FIG. 7(a), (hereinafter, first frame), three each of the horizontal lines 23 provided continuously are sequentially bound to form one set in the liquid crystal panel 6. Further, a plurality of first image forming areas 21a, 21b, 21c and second image forming areas 22a, 22b, 22c are alternately arranged across the boundaries 25a, 25b, 25c in the liquid crystal panel 6 in association with respective sets as shown in FIGS. 7(a) to 7(f).

That is, with the switching retarder 8 illustrated in FIGS. 7(a) to 7(f), three phase difference portions 33 provided continuously are sequentially bound to form one set in the first frame. Further, a plurality of first polarizing areas 31a, 31b, 31c and second polarizing areas 32a, 32b, 32c are alternately arranged across the boundaries 35a, 35b, 35c in the switching retarder 8 in association with respective sets.

When image forming areas of a right eye image and a left eye image are replaced in the liquid crystal panel 6 following switching of a frame, the stereoscopic image display apparatus 1 changes positions of the boundaries 25a, 25b and 25c between the first image forming areas 21a, 21b and 21c and the second image forming areas 22a, 22b and 22c of the liquid crystal panel 6.

In this case, the numbers of horizontal lines 23 which form the first image forming areas 21a, 21b, 21c and the second image forming areas 22a, 22b, 22c are prevented from changing from three horizontal lines. As a result, positions to form the first image forming areas 21a, 21b, 21c and the second image forming areas 22a, 22b, 22c are shifted according to the amount of shift of the boundaries 25a, 25b, 25c in the display screen of the liquid crystal panel 6. Further, positions to form the first polarizing areas 31a, 31b, 31c and the second polarizing areas 32a, 21b, 32c are also shifted likewise in the corresponding switching retarder 8, and the boundaries 35a, 35b, 35c are shifted according to the shifting of the boundaries 25a, 25b, 25c of the liquid crystal panel 6.

In addition, when, for example, the boundaries 25b and 25c are shifted in the liquid crystal panel 6 as in a third frame to a sixth frame illustrated in FIGS. 7(c) to 7(f), the uppermost and lowermost first image forming areas 22b and 22c of the liquid crystal panel 6 are not formed with three forming horizontal lines, and have different areas from the other image forming areas. Similarly, when the boundaries 35b and 35c are also shifted in the switching retarder 8, the uppermost and lowermost second polarizing areas 32b and 32c are not formed with three forming phase difference portions 33, and have different areas from the other polarizing areas. This difference is a little one in an entire display image, and is hardly perceived by the viewer 50.

Following progress of a frame which displays an image, the stereoscopic image display apparatus 1 sequentially shifts the boundaries 25a, 25b and 25c between the first image forming areas 21a, 21b and 21c and the second image forming areas 22a, 22b and 22c of the liquid crystal panel 6 downward per horizontal line. Further, when the boundaries 25a, 25b and 25c are sequentially moved per horizontal line and the shifts of the boundaries 25a, 25b and 25c reach three horizontal lines which is the number of horizontal lines 23 which form the first image forming areas 21a, 21b and 21c and the second image forming areas 22a, 22b and 22c, the boundaries 25a, 25b and 25c return the positions again in the first display frame. Similarly, the boundaries 35a, 35b and 35c are also moved in the switching retarder 8.

As a result, as shown in FIG. 7(a), in the stereoscopic image display apparatus 1, in a first frame, for example, right eye image light having transmitted through the first image forming areas 21a is incident on the first polarizing areas 31a of the switching retarder 8. Further, left eye image light having transmitted through the second image forming areas 22a is incident on the second polarizing areas 32a. Subsequently, image forming areas of a right eye image and a left eye image in the liquid crystal panel 6 are replaced following switching of a frame. In this case, the position of the boundary 25a is not changed in the next display frame (also referred to a “second frame” below) in FIG. 7(b), and left eye image light having transmitted through the first image forming areas 21a is incident on the first polarizing area 31a at the same position as that in the first frame of the switching retarder 8. Still further, the right eye image light having transmitted through the second image forming areas 22a is incident on the second polarizing areas 32a.

As illustrated in FIG. 7(c), in the subsequent display frame (also referred to as a “third frame” below), image forming areas of a right eye image and a left eye image in the liquid crystal panel 6 are replaced, and the boundary 25b is moved. The boundary 25b between the first image forming area 21b and the second image forming area 22b is shifted one horizontal line downward from the original position. In this case, in synchronization with replacement of the image forming areas of the right eye image and the left eye image of the liquid crystal panel 6, the boundary 35b between the first polarizing area 31b and the second polarizing area 32b in the switching retarder 8 is shifted one horizontal line downward from the original position. As a result, right eye image light having transmitted through the first image forming area 21b is incident on the first polarizing area 31b at a position shifted one phase different portion from the first frame of the switching retarder 8. Still further, the left eye image light having transmitted through the second image forming areas 22b is incident on the second polarizing areas 32b.

As illustrated in FIG. 7(d), although image forming areas of a right eye image and a left eye image in the liquid crystal panel 6 are replaced in one next display frame (also referred to a “fourth frame” below), the position of the boundary 25b is not changed. Hence, similarly, the position of the boundary 35b is not changed in the switching retarder 8. Consequently, in the fourth frame, left eye image light having transmitted through the first image forming area 21b is incident on the first polarizing area 31b at the same position as in that in the third frame of the switching retarder 8. Still further, the right eye image light having transmitted through the second image forming areas 22b is incident on the second polarizing areas 32b.

As illustrated in FIG. 7(e), in one subsequent display frame (also referred to as a “fifth frame” below), image forming areas of a right eye image and a left eye image in the liquid crystal panel 6 are replaced again, and the boundary 25c between the first image forming area 21c and the second image forming area 22c is shifted one horizontal line downward from the position in the third frame. In this case, in synchronization with replacement of the image forming areas of the right eye image and the left eye image of the liquid crystal panel 6, the boundary 35c between the first polarizing area 31c and the second polarizing area 32c in the switching retarder 8 is shifted one horizontal line downward from the position in the third frame. The boundary 35c is also moved accordingly in the switching retarder 8. As a result, right eye image light having transmitted through the first image forming area 21c is incident on the first polarizing area 31c at a position shifted two phase different portion from the first frame of the switching retarder 8. Still further, the left eye image light having transmitted through the second image forming areas 22c is incident on the second polarizing areas 32c.

As illustrated in FIG. 7(f), although image forming areas of a right eye image and a left eye image in the liquid crystal panel 6 are replaced in the next display frame (also referred to a “sixth frame” below), the position of the boundary 25c is not changed. Hence, similarly, the position of the boundary 35c is not changed in the switching retarder 8. As a result, in the fifth frame, left eye image light having transmitted through the first image forming area 21c is incident on the first polarizing area 31c at the same position as in that in the fifth frame of the switching retarder 8. Still further, the right eye image light having transmitted through the second image forming areas 22c is incident on the second polarizing areas 32c.

Moreover, in the subsequent display frames (also referred to as a “seventh frame” below) (not illustrated), image forming areas of a right eye image and a left eye image in the liquid crystal panel 6 are replaced again, and the boundary 25c between the first image forming area 21c and the second image forming area 22c is shifted one horizontal line downward from the original position. In this case, in synchronization with replacement of the image forming areas of the right eye image and the left eye image of the liquid crystal panel 6, the boundary 35c between the first polarizing area 31c and the second polarizing area 32c in the switching retarder 8 is shifted one horizontal line downward from the original position.

As a result, compared to the first frame, in the seventh frame, the boundary 25a is shifted three horizontal lines in the liquid crystal panel 6, and returns to the original position upon the first frame. Similarly, the boundary 35a also returns to the original position upon the first frame in the switching retarder 8. Further, the stereoscopic image display apparatus 1 repeats image formation in the liquid crystal panel and the switching retarder 8 of the liquid crystal display 3 according to the same method.

Then, by moving the boundaries 25 between the first image forming areas 21 and the second image forming areas 22 without fixing the boundaries 25, it is possible to uniformly distribute positions at which crosstalk occurs, in the entire display screen. As a result, viewers 50 can view smoother stereoscopic images with little unevenness and little crosstalk, which is the original object of this invention.

In addition, in the above example, when image forming areas of a right eye image and a left eye image in the liquid crystal panel 6 are replaced following switching of a frame, only if an image formed in the first image forming areas 21a, 21b and 21c is changed from the left eye image to the right eye image are the boundaries 25a, 25b and 25c moved. When the right eye image is replaced to the left eye image, the boundaries 25a, 25b and 25c are not moved. Hence, only when an image to be formed is changed from a right eye image to a left eye image are the boundaries 25a, 25b and 25c moved in the second image forming areas 22a, 22b and 22c. Accordingly, the viewer 50 can view a natural stereoscopic image.

Further, according to another configuration example, as described above, without sequentially shifting the boundaries 25a, 25b and 25c between the first image forming areas 21a, 21b and 21c and the second image forming areas 22a, 22b and 22c per horizontal line, it is also possible to change positions of the first image forming areas 21a, 21b and 21c and the second image forming areas 22a, 22b and 22c at random. Furthermore, the positions to form the first polarizing area 31a, 31b and 31c and the second polarizing areas 32a, 32b and 32c are also changed accordingly in the switching retarder 8. In that case, more specifically, in the example illustrated in FIG. 7, it is possible to perform image formation performed in the fifth frame in FIG. 7(e) and the sixth frame in FIG. 7(f) prior to image formation performed in the third frame in FIG. 7(c) and the fourth frame in FIG. 7(d). In this case, the positions to form the boundaries 35a, 35b and 35c between the first polarizing areas 31a, 31b and 31c and the second polarizing areas 32a, 32b and 32c are not fixed, so that it is also possible to provide the same effect as the above.

As mentioned above, although the image forming performed using a liquid crystal display 3 and a switching retarder 8 in the stereoscopic image display apparatus 1 according to the present embodiment has been described, specific configuration examples of the switching retarder 8 which realizes the image forming will be described next.

As illustrated in FIG. 4, the switching retarder 8 of the stereoscopic image display apparatus 1 according to the present embodiment can induce a change of the orientation of the liquid crystal 116 by applying the voltage to the transparent electrodes 119 and 120 on the substrates 114 and 115. The switching retarder 8 can be formed using various liquid crystal modes used for the liquid crystal display. For example, the switching retarder 8 can be formed with a TN (Twisted Nematic) liquid crystal element, homogeneous liquid crystal element or ferroelectric liquid crystal element.

Hereinafter, configuration examples of the switching retarder 8 according to the present embodiment will be described using FIG. 4 and other diagrams. In addition, common members of each configuration example will be assigned common reference numerals for ease of description.

First, a manufacturing method and configuration using a TN liquid crystal element will be described as the first configuration example of the switching retarder 8 according to the present embodiment.

To manufacture the switching retarder 8 utilizing a TN liquid crystal element, the substrates 114 and 115 are first prepared. Glass substrates can be used for the substrates 114 and 115. Further, it is also possible to use a substrate formed with a glass cloth reinforced transparent film which is thinner than a glass substrate thus making the substrate thinner and increasing the above effect of reducing crosstalk.

Next, transparent conductive layers (for example, ITO films) having the thicknesses of 100 nm to 140 nm are formed on the respective substrates 114 and 115 using the sputtering method. Then, the transparent electrodes 119 and 120 are formed by patterning the transparent conductive layers using the photolithography method.

Next, the oriented films 117 and 118 having the thicknesses of 50 nm are formed on the transparent electrodes 119 and 120 using a spin coating method such that the liquid crystal is horizontally oriented at a predetermined pre-tilting angle, and rubbing processing is applied to these oriented films 117 and 118. In this case, the rubbing processing is applied to the oriented films 117 and 118 such that the rubbing directions are orthogonal to each other when the substrates 114 and 115 are arranged to oppose to each other.

Next, a pair of the substrates 114 and 115 is adhered such that the cell gap, which is an inter-substrate distance therebetween, is 5.2 μM. More specifically, both the substrates are fixed by coating plastic spacers (not illustrated) on one substrate, arranging a pair of the substrates 114 and 115 to oppose to each other, and curing a pair of the substrates 114 and 115 by a thermosetting adhesive printed in the surrounding of the display area.

Next, the liquid crystal 116 is formed by filling a liquid crystal material in the gap between the substrates 114 and 115 using a vacuum injection method. Meanwhile, for the liquid crystal material, a nematic liquid crystal material is used which has the refractive index anisotropy (Δn) of 0.0924 and contains 0.15 wt % of an optically-active material CB 15. As mentioned above, the liquid crystal 116 is placed in a 90 degree twisted orientation state in the initial state where no voltage is applied to the liquid crystal 116. Hence, by inducing the change of the orientation of the liquid crystal 116, the switching retarder 8 utilizing the TN liquid crystal element functions to switch between two states, i.e., a state where the liquid crystal 116 optically rotates at 90 degrees and the state where the liquid crystal 116 does not have such an optical rotation. In addition, when the liquid crystal 116 optically rotates at 90 degrees, the switching retarder 8 utilizing the TN liquid crystal element can output image light which is incident as linear polarized light having the polarizing axis in a direction vertical to the horizontal direction, as linear polarized light parallel to the horizontal direction.

Next, the switching retarder 8 utilizing the TN liquid crystal element is positioned to correspond to the pixels of the above liquid crystal display 3 for displaying pixels. Then, the switching retarder 8 is adhered by means of the adhesive 101.

Next, a manufacturing method and configuration using a homogeneous liquid crystal element will be described as a second configuration example of the switching retarder 8 according to the present embodiment. To manufacture the switching retarder 8 utilizing the homogeneous liquid crystal element, the substrates 114 and 115 are first prepared. Glass substrates can be used for the substrates 114 and 115. Further, it is also possible to use a substrate formed with a glass cloth reinforced transparent film which is thinner than a glass substrate thus making the substrate thinner and increasing the above effect of reducing crosstalk.

Next, transparent conductive layers (for example, ITO films) having thicknesses of 100 nm to 140 nm are formed on the respective substrates 114 and 115 using the sputtering method. Then, the transparent electrodes 119 and 120 are formed by patterning the transparent conductive layers using the photolithography method.

Then, the oriented films 117 and 118 having the thicknesses of 50 nm are formed on the transparent electrodes 119 and 120 using the spin coating method such that the liquid crystal is horizontally oriented at a predetermined pre-tilting angle, and rubbing processing is applied to these oriented films 117 and 118. The rubbing processing is applied to these oriented films 117 and 118 such that the rubbing directions are parallel to each other when the substrates 114 and 115 are arranged to oppose to each other and the orientation direction is in the direction of the upper left at 45 degrees (the upper left at 45 degrees when viewing the drawings) when the viewer 50 faces the stereoscopic image display apparatus 1.

Next, a pair of the substrates 114 and 115 is adhered such that a cell gap, which is an inter-substrate distance therebetween, is 1.03 μM. More specifically, both the substrates are fixed by coating plastic spacers (not illustrated) on one substrate, arranging a pair of the substrates 114 and 115 to oppose to each other, and curing a pair of the substrates 114 and 115 by a thermosetting adhesive 101 printed in the surrounding of the display area.

Then, the liquid crystal 116 is formed by filling a liquid crystal material (BL035, Δn=0.267 and made by Merck KGaA) in the gap between the substrates 114 and 115 using a vacuum injection method. By doing so, a portion of the liquid crystal 116 of the switching retarder 8 formed using the homogeneous liquid crystal element has a phase difference value corresponding to the ½ wavelength based on 550 nm. Hence, by inducing the change of the orientation of the liquid crystal 116 per polarizing area, the switching retarder 8, using the homogeneous liquid crystal element, functions to switch between two states, i.e., a state where there is no phase difference and the state of the 1/2 wave plate where the phase difference is the ½ wavelength. Next, the switching retarder 8 utilizing the homogeneous liquid crystal element is positioned to correspond to the pixels of the above liquid crystal display 3 for displaying pixels. Then, the switching retarder 8 is adhered by means of the adhesive 101.

Further, a manufacturing method and configuration using a ferroelectric liquid crystal element will be described as a third configuration example of the switching retarder 8 according to the present embodiment. To manufacture the switching retarder 8 utilizing a ferroelectric liquid crystal element, the substrates 114 and 115 are first prepared. Glass substrates can be used for the substrates 114 and 115. Further, it is also possible to use a substrate formed with a glass cloth reinforced transparent film which is thinner than a glass substrate thus making the substrate thin and increasing the above effect of reducing crosstalk.

Next, transparent conductive layers (for example, ITO films) having thicknesses of 100 nm to 140 nm are formed on the respective substrates 114 and 115 using the sputtering method. Then, the transparent electrodes 119 and 120 are formed by patterning the transparent conductive layers using the photolithography method.

Then, the photo-alignment oriented films 117 and 118 having thicknesses of 30 nm are formed on the transparent electrodes 119 and 120 using the spin coating method such that liquid crystal is horizontally oriented, and photo-aligning technique is applied to these oriented films 117 and 118 to form horizontally oriented films

Next, a pair of the substrates 114 and 115 is adhered such that a cell gap, which is an inter-substrate distance therebetween is 3 μM. More specifically, both the substrates are fixed by coating plastic spacers (not illustrated) on one substrate, arranging a pair of the substrates 114 and 115 to oppose to each other, and curing a pair of the substrates 114 and 115 by a thermosetting adhesive 101 printed in the surrounding of the display area.

Then, the liquid crystal 116 is formed by filling a ferroelectric liquid crystal material (Δn=0.25 and cone angle 45 degrees) in the gap between the substrates 114 and 115 using the vacuum injection method. In addition, assuming that the liquid crystal modulation factor is about 70%, Δn of the liquid crystal and the cell gap are selected such that the phase difference of the liquid crystal 116 has the ½ wavelength at this modulation factor.

Further, the switching retarder 8 utilizing a ferroelectric liquid crystal element is formed such that optical axes of the liquid crystals 116 are shifted 45 degrees in the first polarizing areas 31 and the second polarizing areas 32 depending on whether or not a voltage is applied. That is, the switching retarder 8 utilizing a ferroelectric liquid crystal element is formed such that the optical axis of the liquid crystal 116 of the first polarizing areas 31 is in the horizontal direction 1 or in the direction of the upper left at 45 degrees (the upper left at 45 degrees when viewing the drawings) from the horizontal direction when the viewer 50 faces the stereoscopic image display apparatus depending on whether or not an orientation change of a ferroelectric liquid crystal is induced per polarizing area. Further, the second polarizing areas 32 have a different state from the first polarizing areas 31, and the optical axis is in the direction of the upper left at 45 degrees (the upper left at 45 degrees when viewing the drawings) from the horizontal direction, or in the horizontal direction.

Next, the switching retarder 8 utilizing the ferroelectric liquid crystal element is positioned to correspond to the pixels of the above-mentioned liquid crystal display 3 for displaying pixels. Then, the switching retarder 8 is adhered by means of the adhesive 101.

Although the specific configuration example of the switching retarder 8 has been described, patterning of the transparent electrodes 119 and 120 of this configuration will now be described. Various liquid crystal elements used in the switching retarder 8 according to the present embodiment adopt different structures from patterns of transparent electrodes compared to liquid crystal elements used in a conventional display element.

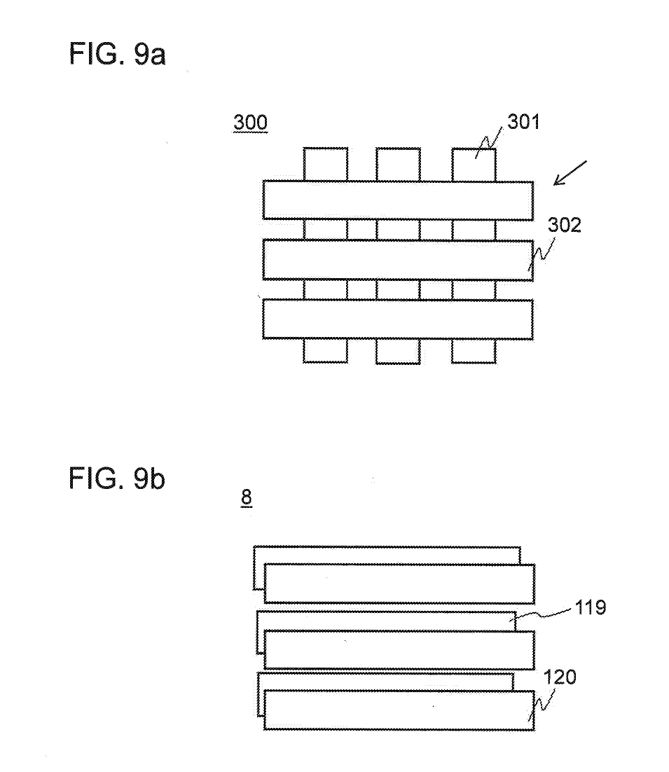

FIG. 9 is a view explaining an electrode pattern which forms a liquid crystal element. FIG. 9(a) is a view schematically illustrating an electrode structure of a conventional passive driving liquid crystal display element, and FIG. 9(b) is a view schematically illustrating an electrode structure of the switching retarder 8 according to the present embodiment. As illustrated in FIG. 9(a), in a conventional passive driving liquid crystal display element 300, upper electrodes 302 and lower electrodes 301 are respectively patterned in a stripe pattern, and disposed in a matrix pattern to be orthogonal to each other.

By contrast with this, as illustrated in FIG. 9(b), in the switching retarder 8 according to the present embodiment, when passive driving is performed, the upper transparent electrodes 120 and the lower transparent electrodes 119 are respectively patterned in a stripe pattern and are preferably parallel without being disposed in a matrix pattern.

In addition, it is possible to pattern the transparent electrodes 119 and 120 by determining the sizes thereof according to the sizes and positional relationship of the first image forming areas 21 and the second image forming areas 22 of the liquid crystal panel 6. That is, in the liquid crystal panel 6, a desired number of horizontal lines 23 are bound as one set to form the first image forming areas 21 and the second image forming areas 22. Further, in the switching retarder 8, it is possible to pattern the transparent electrodes 119 and 120 to appropriate sizes to correspond to the positions and sizes of the first image forming areas 21 and the second image forming areas 22, and form the first polarizing areas 31 and the second polarizing areas 32 in the switching retarder 8.

Further, it is also possible to pattern the transparent electrodes 119 and 120 similar to the liquid crystal panel 6 by determining the sizes and positional relationship to correspond to each of the horizontal lines 23 of the liquid crystal panel 6. Further, while a desired number of horizontal lines 23 are bound as one set in the liquid crystal panel 6, it is possible to form the sets of the same configuration in the transparent electrodes 119 and 120. As a result, it is possible to form the first polarizing areas 31 and the second polarizing areas 32 of the switching retarder 8 with corresponding sets of transparent electrodes 119 and sets of transparent electrodes 120. Further, it is possible to induce the same change of the orientation of the liquid crystal 116 per area of the first polarizing areas 31 and the second polarizing areas 32. That is, by performing switching in the switching retarder 8, it is possible to realize orientation states of the liquid crystal different from the previous states in the first polarizing areas 31 and the second polarizing areas 32.

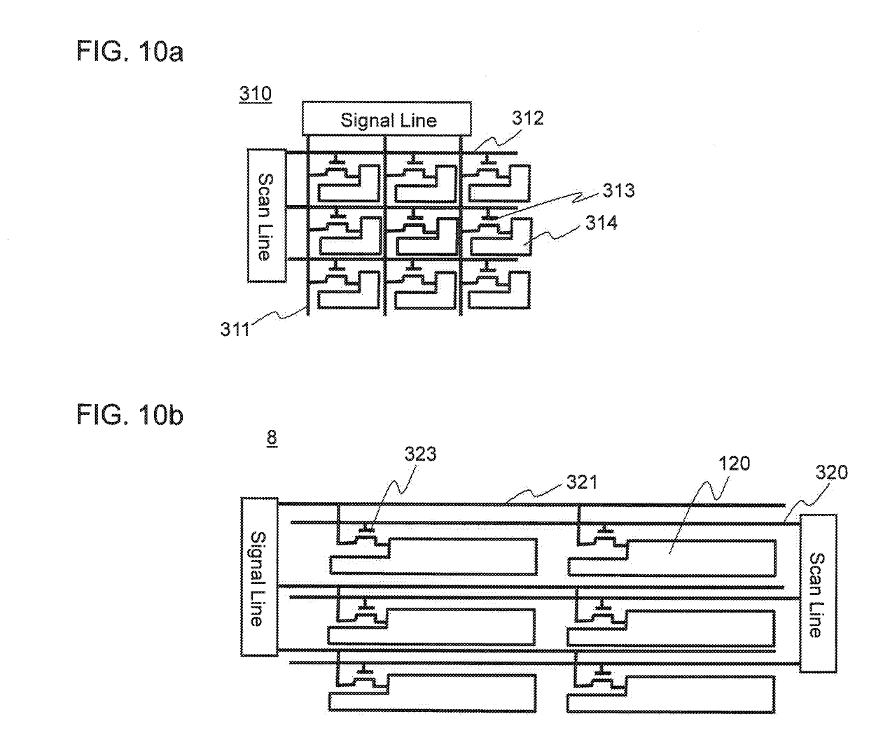

Further, it is also possible to form the switching retarder 8 according to the present embodiment using the active driving liquid crystal element. FIG. 10(a) is a view schematically illustrating a configuration of a conventional active driving liquid crystal element 310, and FIG. 10(b) is a view schematically illustrating a configuration of a main part of the switching retarder 8 according to the present embodiment using the active driving liquid crystal element.

As illustrated in FIG. 10(a), in the conventional active driving liquid crystal element 310, scan lines 312 and signal lines 311 are disposed in a matrix pattern to be orthogonal to each other, and at their intersections, active elements 313 and pixel electrodes 314 are provided. By contrast with this, as illustrated in FIG. 10b), if the switching retarder 8 according to the present embodiment is formed using the active driving liquid crystal element, the scan lines 320 and the signal lines 321 are disposed to be parallel. Further, the pixel electrode, which is the upper transparent electrode 120, adopts a horizontally long structure, which can drive the liquid crystal 116 by means of the active element 323 of the pixel electrode, and is preferably the maximum width.

Further, when the active element 323 and the transparent electrode 120 are formed, the transparent electrode 120 is patterned by determining the sizes and positional relationship of the transparent electrode 120 to correspond to each of all horizontal lines 23 of the liquid crystal panel 6, and provide the active element for each transparent electrode 120. In this case, according to selection of the number of horizontal lines 23 to be bound as one set in the liquid crystal panel 6, a predetermined number of combinations of the active elements 323 and the transparent electrodes 120 are bound as one set. Further, it is possible to form the first polarizing areas 31 and the second polarizing areas 32 of the switching retarder 8 with these sets. Further, by driving each set in the same manner and inducing the same change of an orientation state of the liquid crystal 116, switching is performed in the switching retarder 8. As a result, it is possible to realize the orientation states of the liquid crystal different from the previous states in the first polarizing areas 31 and the second polarizing areas 32.

As described above, the stereoscopic image display apparatus 1 according to the present embodiment illustrated in FIG. 1 forms an image of reduced crosstalk using the liquid crystal display 3 and the switching retarder 8, and the viewer 50 wears the polarizing eyeglasses 10 and views a stereoscopic image.

Next, a function of the switching retarder 8 which forms the stereoscopic image display apparatus 1 according to the present embodiment, and the polarizing eyeglasses 10 will be described using FIGS. 1, 4 and 11.

As described above, in the state where the stereoscopic image display apparatus 1 is used, when one frame image is displayed, either a right eye image or a left eye image are generated on the first image forming areas 21, and the other eye image are generated on the second image forming areas 22 of the liquid crystal panel 6. When light transmitted through the polarizing plate 5 is incident on the first image forming areas 21 and the second image forming areas 22 of the liquid crystal panel 6, right eye image light and left eye image light are formed. Right eye image light transmitted through the first image forming areas 21 and left eye image light transmitted through the second image forming areas 22 transmit through the polarizing plate 7, and become linear polarized lights having polarizing axes in respective specific directions. Meanwhile, respective directions are the same direction as the direction of the transmission axis of the polarizing plate 7.

As a result, as illustrated in FIG. 4, for example, right eye image light is incident on the first polarizing areas 31, of the switching retarder 8, as linear polarized light having the polarizing axis in the direction vertical to the horizontal direction. Further, selection of the orientation state of the liquid crystal 116 and the function of the phase difference film 121 enable this incident right eye image light to be output as counterclockwise circular polarized light. Further, similarly in this case, with the second polarizing area 32, selection of the orientation state of the liquid crystal 116 and the function of the phase difference film 121 enable incident left eye image light to be output as clockwise circular polarized light.

Next, performing switching in the switching retarder 8 and changing the orientation state of the liquid crystal 116 allows the realization of different orientation states from the previous orientation states of the liquid crystal 116 in the first polarizing areas 31 and the second polarizing areas 32. In this case, the change of the orientation state and the function of the phase difference film 121 enable left eye image light incident on the first polarizing areas 31 to be output as clockwise circular polarized light. Further, with the second polarizing area 32, selection of the orientation state of the liquid crystal 116 and the function of the phase difference film 121 enable incident right eye image light to be output as counterclockwise circular polarized light.

Accordingly, right eye image light transmitted through the first polarizing areas 31 and left eye image light transmitted through the second polarizing areas 32 become circular polarized lights with the rotation directions opposite to each other as indicated by the arrow shown in FIG. 1. In addition, the arrow in the switching retarder 8 in FIG. 1 schematically indicates the rotation direction of polarized light transmitted through this switching retarder 8.

Further, the above stereoscopic image display apparatus 1 may have a diffusing plate which diffuses right eye image light and left eye image light transmitted through the first polarizing areas 31 and the second polarizing areas 32 of the switching retarder 8 in at least one of the horizontal direction and vertical direction positioned on the side of the switching retarder 8 between the viewer and the switching retarder 8. For this diffusing plate, a lenticular lens sheet in which a plurality of D-shaped convex lenses (cylindrical lenses), which extend in the horizontal direction or vertical direction are arranged, or a lens array sheet in which a plurality of convex lenses are arranged in a plane shape is used.

When the viewer 50 views stereoscopic images using the stereoscopic image display apparatus 1, the viewer 50 views right eye image light and left eye image light projected from the stereoscopic image display apparatus 1 while wearing the polarized glasses 10. With these polarized glasses 10, a right eye glass 41 is arranged in the position corresponding to the right eye of the viewer 50 and a left eye glass 42 is arranged in the position corresponding to the left eye of the viewer 50.

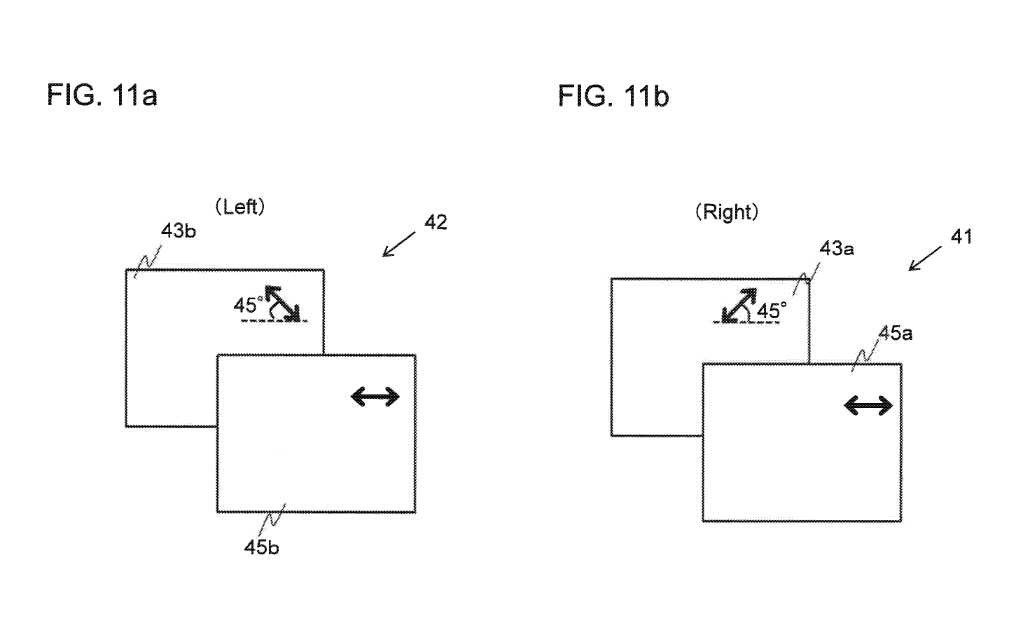

FIG. 11 is a schematic exploded perspective view illustrating configurations of the right eye glass 41 and the left eye glass 42. Specifically, FIG. 11(a) illustrates the configuration of the left eye glass 42, and FIG. 11(b) illustrates the configuration of the right eye glass 41.

As illustrated in FIGS. 11(a) and 11(b), the right eye glass 41 and the left eye glass 42 forming the polarized glasses 10 have ¼ wave plates 43a and 43b and polarizing plates 45a and 45b, respectively, in this order, and these are fixed to the frame.

In this case, with the polarized glasses 10 according to the present embodiment, when the viewer 50 faces the liquid crystal display 3 wearing the polarized glasses 10, the optical axis of the ¼ wave plate 43a of the right eye glass 41 is in a direction of the upper right at 45 degrees (the upper right at 45 degrees when viewing the drawings) from the horizontal direction. Further, the transmission axis of the polarizing plate 45a is in a direction parallel to the horizontal direction. Hence, right eye image light and left eye image light which are respectively circular polarized lights transmitted through the first polarizing areas 31 and the second polarizing areas 32 of the switching retarder 8 of the stereoscopic image display apparatus 1 are incident on the ¼ wave plates 43a and 43b provided in the right eye glass 41 and the left eye glass 42 and output as linear polarized lights according to the functions of the ¼ wave plates 43a and 43b.

The configuration of the stereoscopic image display apparatus 1 according to the present embodiment has been described, and a method will be next described which makes the viewer 50 recognize stereoscopic images based on right eye image light and left eye image light using the stereoscopic image display apparatus 1 according to the present embodiment.

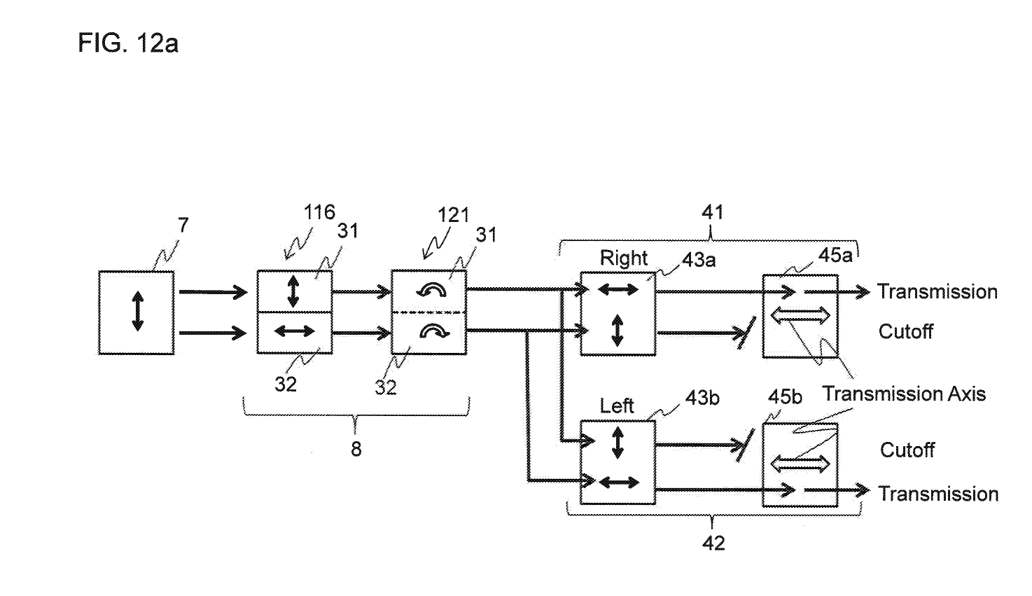

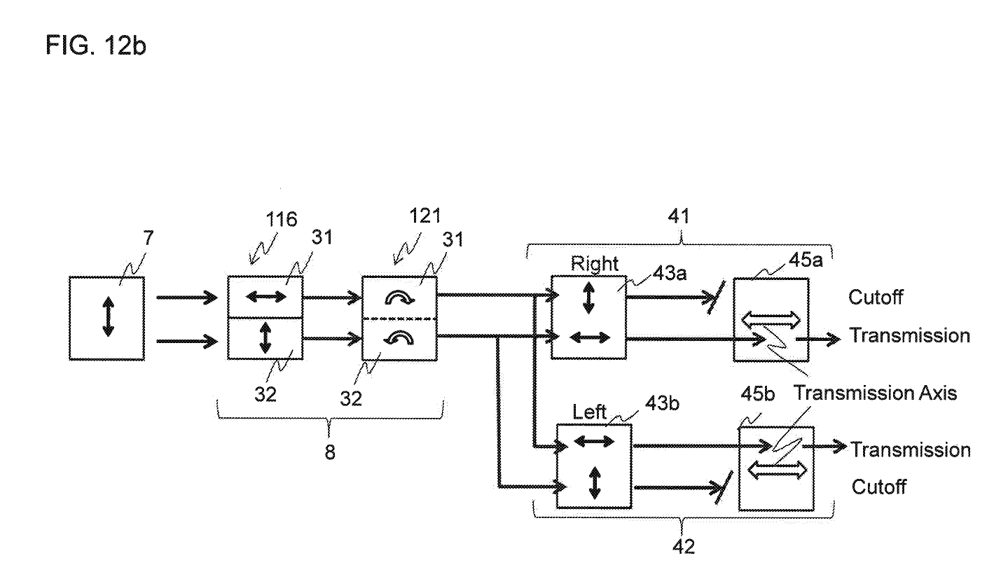

FIGS. 12(a) and b are views describing a method of allowing the viewer 50 to recognize stereoscopic images using the stereoscopic image display apparatus 1 according to the present embodiment. Further, FIG. 12(a) is a view describing a method of allowing the viewer 50 to recognize one frame image, and FIG. 12(b) is a view describing a method of allowing the viewer 50 to recognize a frame image after image display areas are replaced following switching of a frame.

When the viewer 50 views stereoscopic images using the stereoscopic image display apparatus 1, if one frame image is displayed, either a right eye image or a left eye image are generated on the first image forming areas 21, and the other eye image are generated on the second image forming areas 22 of the liquid crystal panel 6.

Further, as indicated by the arrow in FIG. 12(a), right eye image light transmitted through the first image forming areas 21 and left eye image light transmitted through the second image forming areas 22 transmit through the polarizing plate 7, and become linear polarized lights having polarizing axes in a direction vertical to the horizontal direction.

Then, the right eye image light and the left eye image light are incident on the switching retarder 8. In this case, in the first polarizing areas 31 of the liquid crystal 116, the switching retarder 8 allows linear polarized light incident from the polarizing plate 7 to be incident on the phase difference film 121. Further, in the second polarizing areas 32, linear polarized light is converted to have a polarizing axis in a direction parallel to the horizontal direction and be incident on the phase difference film 121.

Hence, as indicated by the arrow in FIG. 12(a), in the first polarizing areas 31 of the switching retarder 8 on which right eye image light is incident, this incident right eye image light is emitted as counterclockwise circular polarized light. Further, as indicated by the arrow in FIG. 12(a), in the second polarizing areas 32, incident left eye image light is emitted as clockwise circular polarized light.

Next, the right eye image light and the left eye image light obtained in this way are incident on the polarized glasses 10 which are worn by the viewer 50. As illustrated in FIGS. 11(a) and 11(b), the polarized glasses 10 have the right eye glass 41 and the left eye glass 42. In this case, with the polarized glasses 10, right eye image light transmits through the ¼ wave plate 43a provided in the right eye glass 41, is converted into linear polarized light parallel to the horizontal direction and reaches the right eye of the viewer 50.

By contrast with this, when right eye image light which is counterclockwise circular polarized light is incident on the left eye glass 42, as indicated by the arrow in FIG. 12(a), the right eye image light transmits through the ¼ wave plate 43b provided in the left eye glass 42 and is converted into linear polarized light vertical to the horizontal direction. Further, although the right eye image light is incident on the polarizing plate 45b, the right eye image light cannot transmit through and is blocked by the polarizing plate 45b and does not reach the left eye of the viewer 50.

Further, the left eye image light which is clockwise circular polarized light transmits through the ¼ wave plate 43b provided in the left eye glass 42, is converted into linear polarized light parallel to the horizontal direction, and reaches the left eye of the viewer 50.

By contrast with this, when left eye image light which is clockwise circular polarized light is incident on the right eye glass 41, the left eye image light transmits through the ¼ wave plate 43a provided in the right eye glass 41 and is converted into linear polarized light vertical to the horizontal direction. Further, although the left eye image light is incident on the polarizing plate 45a, the left eye image light cannot transmit through and is blocked by the polarizing plate 45a, and does not reach the right eye of the viewer 50.

Thus, when the viewer 50 views the stereoscopic image display apparatus 1 wearing the polarized glasses 10 as described above in the range where right eye image light and left eye image light transmitted through the first polarizing areas 31 and the second polarizing areas 32 of the switching retarder 8 are emitted, the right eye can view only right eye image light and the left eye can view only left eye image light. Consequently, the viewer 50 can recognize these right eye image light and left eye image light as stereoscopic images.

Next, a case will be described where, as illustrated in FIG. 12(b), when the viewer 50 views a stereoscopic image using the stereoscopic image display apparatus 1, image areas are replaced following switching of a frame as described above. That is, a case will be described where a left eye image and a right eye image are formed respectively on the first image forming areas 21 and the second image forming areas 22 in the liquid crystal panel 6 after switching of a frame.

In this case, following replacement of image areas following switching of a frame, phase difference states of the first polarizing areas 31 and the second polarizing areas 32 are switched in the switching retarder 8. More specifically, the phase difference state of the first polarizing areas 31 switches to the same phase difference state of the second polarizing areas 32 before switching of a frame. Further, the phase difference state of the second polarizing areas 32 switches to the same phase difference state as the phase difference state of the first polarizing areas 31 before switching of a frame.

Hence, similar to the above case, left eye image light transmitted through the first image forming areas 21 in the liquid crystal panel 6 and right eye image light transmitted through the second image forming areas 22 in the liquid crystal panel 6 transmit through the polarizing plate 7 as indicated by the arrow in FIG. 12(b), and become linear polarized lights respectively having polarizing axes vertical to the horizontal direction.

Further, although left eye image light and right eye image light are incident on the switching retarder 8, the left eye image light is incident on the first polarizing areas 31 of the switching retarder 8. Furthermore, as indicated by the arrow in FIG. 12(b), this incident left eye image light is emitted as clockwise circular polarized light. Still further, in the second polarizing areas 32, incident right eye image light is emitted as counterclockwise circular polarized light. Next, the left eye image light and the right eye image light obtained in this way are incident respectively on the polarized glasses 10 which are worn by the viewer 50.

At that time, with the polarized glasses 10, when left eye image light which is clockwise circular polarized light is incident on the right eye glass 41, as indicated by the arrow in FIG. 12(b), the left eye image light transmits through the ¼ wave plate 43a provided in the right eye glass 41 and is converted into linear polarized light vertical to the horizontal direction, is incident on, but cannot transmit through and is blocked by the polarizing plate 45a and therefore does not reach the right eye of the viewer 50.

By contrast with this, left eye image light which is clockwise circular polarized light is incident on the left eye glass 42 and transmits through the ¼ wave plate 43b provided in the left eye glass 42, is converted into linear polarized light parallel to the horizontal direction as indicated by the arrow in FIG. 12(b), transmits through the polarizing plate 45b without changing and reaches the left eye of the viewer 50.

Further, as indicated by the arrow in FIG. 12(b), right eye image light which is counterclockwise circular polarized light transmits through the ¼ wave plate 43a provided in the right eye glass 41, is converted into linear polarized light parallel to the horizontal direction, transmits through the polarizing plate 45a without changing and reaches the right eye of the viewer 50.

By contrast with this, when right eye image light which is counterclockwise circular polarized light is incident on the left eye glass 42, as indicated by the arrow in FIG. 12(b), the right eye image light transmits through the ¼ wave plate 43b provided in the left eye glass 42, is converted into linear polarized light vertical to the horizontal direction, is incident on, but cannot transmit through and is blocked by the polarizing plate 45b and therefore does not reach the left eye of the viewer 50.

Thus, the stereoscopic image display apparatus 1 is viewed wearing the polarized glasses 10 within a range where left eye image light and right eye image light transmitted through the first polarizing areas 31 and the second polarizing areas 32 of the switching retarder 8 are emitted, so that, even if image forming areas to form right eye and left eye images are replaced following switching of a frame, the right eye can view only the right eye image light. Further, the left eye can view only the left eye image light. Consequently, the viewer 50 can recognize these right eye image light and left eye image light as stereoscopic images at all times.

Accordingly, with a conventional stereoscopic image display apparatus, image areas to form right eye and left eye images are fixed, and therefore the vertical resolution is, for example, decreased by half and the resolution is thereby reduced. On the other hand, the stereoscopic image display apparatus 1 according to the present embodiment enables display at the full resolution which fully exercises performance of the liquid crystal display 3 without decreasing the resolution at all.

Further, with a conventional stereoscopic image display apparatus, there are cases where only one of left eye and right eye images are displayed at all times, and there is a time lag to recognize the three dimensions. On the other hand, the stereoscopic image display apparatus 1 according to the present embodiment displays left eye and right eye images at all times and, consequently, can reduce fatigue of the viewer. Further, the stereoscopic image display apparatus 1 also provides the effect of preventing a sense of difference in the stereoscopic view from being produced by misalignment of left and right images which occurs when stereoscopic images are fast moving.

Although the method has been described above which makes the viewer 50 recognize stereoscopic images using the stereoscopic image display apparatus 1 according to the present embodiment, a more detailed function of the switching retarder 8 in this case will be described based on the above-mentioned example. In addition, each specific example will be described by using the same reference numerals assigned to common members for ease of description. The same will apply below.

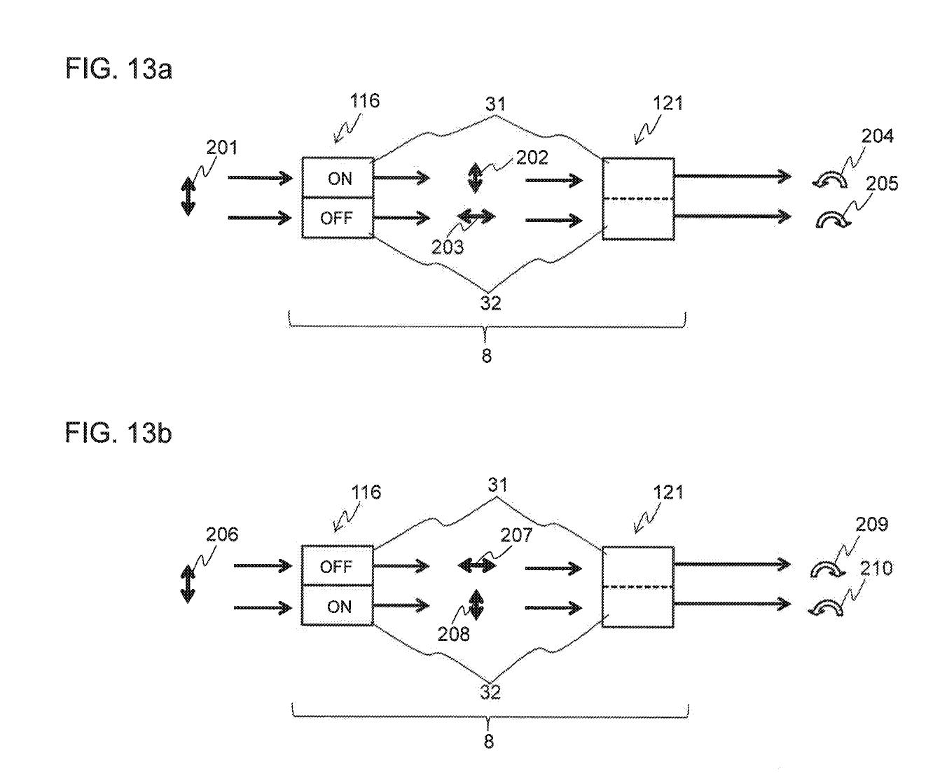

FIGS. 13(a) and b are views illustrating the configuration and function of the switching retarder 8 utilizing a TN liquid crystal element according to the first example of the switching retarder 8 of the present embodiment. Further, FIG. 13(a) illustrates the function of the switching retarder 8 when one frame image is formed, and FIG. 13(b) illustrates the function of the switching retarder 8 when one frame is formed resulting from replacement of image forming areas following switching of a frame.

In the switching retarder 8 utilizing the TN liquid crystal element according to the first example of the switching retarder 8, the transparent electrodes 119 and 120 are patterned to form the phase difference portions 33 corresponding to the horizontal line 23 of the liquid crystal panel 6, and the first polarizing areas 31 and the second polarizing areas 32. Consequently, it is possible to select the on state and select the off state of the liquid crystal upon application of the voltage, independently in the first polarizing areas 31 and the second polarizing areas 32, and independently change the orientation of the liquid crystal.

Consequently, as illustrated in FIG. 13(a), when linear polarized light 201 from the polarizing plate 7 of the liquid crystal display 3 is incident on the switching retarder 8 utilizing the TN liquid crystal element, it is possible to place the liquid crystal 116 of the first polarizing areas 31 of the switching retarder 8 in the on state, and induce a change of the orientation of the liquid crystal. Further, it is possible to place the liquid crystal 116 of the second polarizing areas 32 in the off state without applying the voltage to the liquid crystal 116, and maintain the initial orientation state (90 degree twisted orientation) of the liquid crystal. The first polarizing areas 31 do not apply optical rotation to the light in the state that the liquid crystal 16 is on, as a result the linear polarized light 201 transmits through the first polarizing areas 31 without changing, and is incident on the phase difference film 121 as linear polarized light 202.

Further, the linear polarized light 201 is converted into linear polarized light 203 having the rotated optical axis parallel to the horizontal direction in the second polarizing areas 32, in the state that the liquid crystal 116 is off, having optical rotation, and is incident on the phase difference film 121. Further, the function of the phase difference film 121 which is a ¼ wave plate converts the linear polarized light 202 and the linear polarized light 203 respectively into counterclockwise circular polarized light 204 and clockwise circular polarized light 205.

Next, as illustrated in FIG. 13(b), when linear polarized light 206 from the polarizing plate 7 of the liquid crystal display 3 is incident on the switching retarder 8 utilizing the TN liquid crystal element, the liquid crystal 116 of the first polarizing areas 31 of the switching retarder 8 is placed in the off state without having the voltage applied, and maintains the initial orientation state of the liquid crystal. Further, in the second polarizing areas 32, the liquid crystal 116 is placed in the on state by having the voltage applied, and induces a change of the orientation of the liquid crystal.

As a result, the linear polarized light 206 is converted into linear polarized light 207 having the rotated optical axis parallel to the horizontal direction in the first polarizing areas 31 having optical rotation, and is incident on the phase difference film 121. Further, the linear polarized light 206 transmits as is through the second polarizing area 32 without optical rotation, and is incident on the phase difference film 121 as linear polarized light 208. Further, the function of the phase difference film 121 which is a ¼ wave plate converts the linear polarized light 207 and the linear polarized light 208 respectively into clockwise circular polarized light 209 and counterclockwise circular polarized light 210.

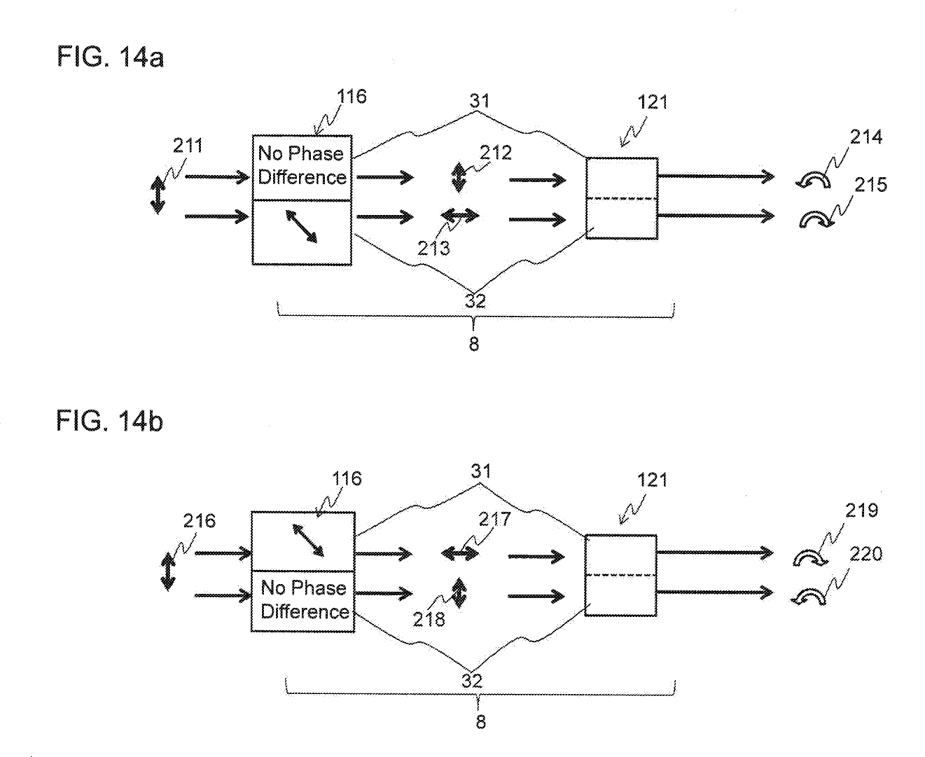

Next, a configuration and function of the switching retarder 8 utilizing the homogeneous liquid crystal element according to the second example of the switching retarder 8 of the present embodiment will be described. FIGS. 14(a) and b are views illustrating the configuration and function of the switching retarder 8 utilizing the homogeneous liquid crystal element according to the second example of the switching retarder 8 of the present embodiment. Further, FIG. 14(a) illustrates the function of the switching retarder 8 when one frame image is formed, and FIG. 14(b) illustrates the function of the switching retarder 8 when a frame image is formed resulting from replacement of image display areas following switching of a frame.

In the switching retarder 8 utilizing the homogeneous liquid crystal element according to the first example of the switching retarder 8, the transparent electrodes 119 and 120 are patterned to form the phase difference portions 33 corresponding to the horizontal line 23 of the liquid crystal panel 6, and the first polarizing areas 31 and the second polarizing areas 32. Consequently, it is possible to select the on state and select the off state of the liquid crystal upon application of the voltage, independently in the first polarizing areas 31 and the second polarizing areas 32, and independently change the orientation of the liquid crystal.

Consequently, as illustrated in FIG. 14(a), when linear polarized light 211 from the polarizing plate 7 of the liquid crystal display 3 is incident on the switching retarder 8 utilizing the homogeneous liquid crystal element, it is possible to place the liquid crystal 116 of the first polarizing areas 31 of the switching retarder 8 in the on state, and induce a change of the orientation of the liquid crystal. Further, it is possible to place the liquid crystal 116 of the second polarizing areas 32 in the off state without applying the voltage to the liquid crystal 116, and maintain the initial orientation state 90 degree twisted orientation of the liquid crystal.

In addition, in this case, the switching retarder 8 utilizing the homogeneous liquid crystal element functions to switch and select between two states, i.e., a state where there is no phase difference and a state where the phase difference is a ½ wavelength. That is, the switching retarder 8 utilizing the homogeneous liquid crystal element can select an area in which there is no phase difference per polarizing area, and an area which functions as a ½ wave plate of the first polarizing areas 31 and the second polarizing areas 32. Further, the initial orientation state of the liquid crystal 116 is a parallel orientation. In addition, the orientation direction is in a direction of the arrow shown in the second polarizing area 32 illustrated in FIG. 14(a), and is in a direction of the arrow shown in the first polarizing area 31 illustrated in FIG. 14(b). That is, the orientation direction is in the direction of the upper left at 45 degrees (upper left at 45 degrees when viewing the drawings) from the horizontal direction. Hence, the second polarizing area 32 in FIG. 14(a) and the first polarizing area 31 in FIG. 14(b) having the liquid crystal 116 in the off state function as a ½ wave plate having the optical axis in the direction of the upper left at 45 degrees.

As a result, the linear polarized light 211 transmits without changing through the first polarizing areas 31 in which there is no the phase difference, and is incident on the phase difference film 121 as linear polarized light 212. Further, the linear polarized light 211 is converted into linear polarized light 213 having the rotated optical axis parallel to the horizontal direction in the second polarizing areas 32 in which the phase difference is the ½ wavelength, and is incident on the phase difference film 121.

Further, the function of the phase difference film 121 which is a ¼ wave plate converts the linear polarized light 212 and the linear polarized light 213 respectively into counterclockwise circular polarized light 214 and clockwise circular polarized light 215.

Next, as illustrated in FIG. 14(b), when linear polarized light 216 from the polarizing plate 7 of the liquid crystal display 3 is incident on the switching retarder 8 utilizing the homogeneous liquid crystal element, the liquid crystal 116 of the first polarizing areas 31 of the switching retarder 8 is placed in the off state without having the voltage applied, and maintains the initial orientation state of the liquid crystal. Further, in the second polarizing areas 32, the liquid crystal 116 is placed in the on state by having the voltage applied to induce a change of the orientation of the liquid crystal.

As a result, the linear polarized light 216 is converted into linear polarized light 217 having the rotated optical axis parallel to the horizontal direction in the first polarizing areas 31 in which there is a phase difference, and is incident on the phase difference film 121. Further, the linear polarized light 216 transmits through the second polarizing areas 32 in which there is no phase difference without changing, and is incident on the phase difference film 121 as linear polarized light 218. Furthermore, the function of the phase difference film 121 which is a ¼ wave plate converts the linear polarized light 217 and the linear polarized light 218 respectively into clockwise circular polarized light 219 and counterclockwise circular polarized light 220.

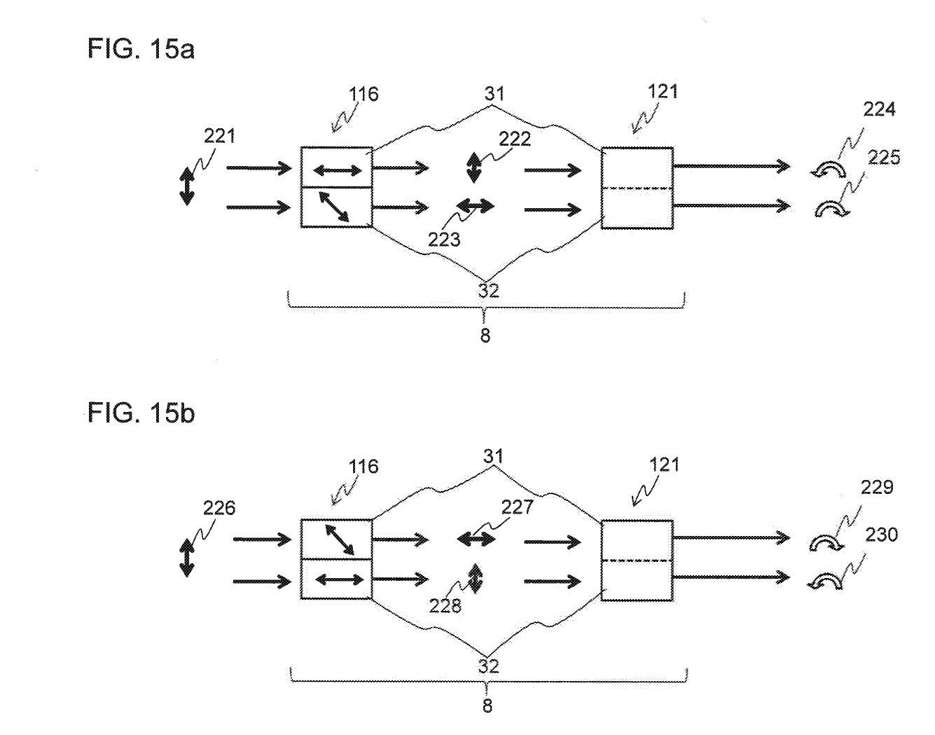

Next, a configuration and function of the switching retarder 8 utilizing the ferroelectric liquid crystal element according to the third example of the switching retarder 8 of the present embodiment will be described. FIGS. 15(a) and b are views illustrating the configuration and function of the switching retarder 8 utilizing the ferroelectric liquid crystal element in the third example of the switching retarder 8 according to the present embodiment. Further, FIG. 15(a) illustrates the function of the switching retarder 8 when one frame image is formed, and FIG. 15(b) illustrates the function of the switching retarder 8 when a frame image is formed following replacement of image display areas following switching of a frame. The switching retarder 8 utilizing the ferroelectric liquid crystal element uses two stable liquid crystal orientation states which can be selected by applying the voltage of a different polarity.

In the switching retarder 8 utilizing the ferroelectric liquid crystal element the phase difference portions 33 are formed corresponding to the horizontal lines 23 of the liquid crystal panel 6, further, the first polarizing areas 31 and the second polarizing areas 32 are also provided. Consequently, it is possible to independently change the orientation of the liquid crystal upon application of the voltage in the first polarizing areas 31 and the second polarizing areas 32.

Consequently, as illustrated in FIG. 15(a), when linear polarized light 221 from the polarizing plate 7 of the liquid crystal display 3 is incident on the switching retarder 8, it is possible to apply voltages of different polarities to the liquid crystal 116 of the first polarizing areas 31 and the liquid crystal 116 of the second polarizing areas 32 of the switching retarder 8, and induce a different orientation change. Further, it is possible to place the liquid crystal 116 of the first polarizing areas 31 and the liquid crystal 116 of the second polarizing areas 32 in oriented states of two different directions. In this case, it is possible to make one oriented direction the horizontal direction when the viewer 50 faces the stereoscopic image display apparatus 1. Further, it is possible to make the other oriented direction the upper left direction at 45 degrees (the upper left at 45 degrees when viewing the drawings) when the viewer 50 faces the stereoscopic image display apparatus 1. As a result, the first polarizing areas 31 and the second polarizing areas 32 function as ½ wave plates having optical axes of different directions.

Hence, as shown in FIG. 15(a), when the voltage of a polarity is applied to the liquid crystal 116, the first polarizing areas 31 function as a ½ wave plate having the optical axis in the horizontal direction. By contrast with this, the voltage of a different polarity is applied to the liquid crystal 116, as a result the second polarizing areas 32 functions as a ½ wave plate having the optical axis in the direction of the upper left at 45 degrees (the upper left at 45 degrees when viewing the drawings) from the horizontal direction.

As a result, the linear polarized light 221 transmits through the first polarizing areas 31 without changing, and is incident on the phase difference film 121 as linear polarized light 222. Further, in the second polarizing areas 32 which have the optical axis in the direction of the upper left at 45 degrees from the horizontal direction and in which the phase difference is the ½ wavelength, the linear polarized light 221 is converted into linear polarized light 223 having the rotated optical axis parallel to the horizontal direction, and is incident on the phase difference film 121.

Furthermore, the function of the phase difference film 121 which is the 1/4 wave plate converts the linear polarized light 222 and the linear polarized light 223 respectively into counterclockwise circular polarized light 224 and clockwise circular polarized light 225.

Next, as illustrated in FIG. 15(b), when the linear polarized light 226 from the polarizing plate 7 of the liquid crystal display 3 is incident on the switching retarder 8, it is possible to induce a change of the orientation of the liquid crystal 116 of the first polarizing areas 31 and the second polarizing areas 32 of the switching retarder 8 by simultaneously applying the voltage of a polarity each different from above, and set the orientation state of a direction each different from above.

As a result, in the first polarizing areas 31, the orientation direction of the liquid crystal 116 upon application of the voltage is in the direction of the upper left at 45 degrees (the upper left at 45 degrees when viewing the drawings) when the viewer 50 faces the stereoscopic image display apparatus 1. By contrast with this, in the second polarizing areas 32, the orientation direction is the horizontal direction when the viewer 50 faces the stereoscopic image display apparatus 1. Consequently, as shown in FIG. 15(b), the first polarizing areas 31 function as the ½ wave plate having the optical axis in the direction of the upper left at 45 degrees (the upper left at 45 degrees when viewing the drawings) from the horizontal direction. By contrast with this, the second polarizing areas 32 function as the ½ wave plate having the optical axis in the horizontal direction.

As a result, in the first polarizing areas 31 which have the optical axis in the direction of the upper left at 45 degrees from the horizontal direction and in which the phase difference is a ½ wavelength, the linear polarized light 226 is converted into linear polarized light 227 having the rotated optical axis parallel to the horizontal direction, and is incident on the phase difference film 121. By contrast with this, the linear polarized light 226 transmits through the second polarizing areas 32 without changing, and is incident on the phase difference film 121 as linear polarized light 228. Further, the function of the phase difference film 121 which is a ¼ wave plate is to converts the linear polarized light 227 and the linear polarized light 228 respectively into clockwise circular polarized light 229 and counterclockwise circular polarized light 230.

Next, the operation for forming the images of the stereoscopic image display apparatus 1 according to the present embodiment will be described in detail. As described above, to display stereoscopic images, the stereoscopic image display apparatus 1 according to the present embodiment simultaneously displays a right eye image and a left eye image on one frame image. Further, the stereoscopic image display apparatus 1 adopts a scheme of sorting images to the left and right eyes of the viewer using the switching retarder of the above optical unit and displaying stereoscopic images. In this case, it is effective to first divide all horizontal scan lines continuously aligned in the vertical direction of the display screen, into the first image forming areas and the second image forming areas each formed with a plurality of horizontal lines in order to display all pieces of image information.

Further, simultaneously displaying one of either a right eye image or a left eye image on the first image forming areas and the other image on the second image forming areas, replacing image forming areas for displaying the left eye image and the right eye image following switching of a frame at a predetermined cycle and, at the same time as the image forming areas are replaced, switching the state of polarization phase differences of the states of first polarizing areas and second polarizing areas of the switching retarder is effective to display and view all pieces of image information.

Further, following replacement of image forming areas of a left eye image and a right eye image appropriately, the stereoscopic image display apparatus 1 according to the present embodiment changes boundaries between first image forming areas and second image forming areas. In this case, areas of the first image forming areas and the second image forming areas, that is, the numbers of horizontal lines which form these, are prevented from changing. As a result, positions to form the first image forming areas and the second image forming areas are shifted according to the amount of shift of the boundaries in the display screen of the liquid crystal panel. Further, positions to form the first polarizing areas and the second polarizing areas are also shifted likewise in the corresponding switching retarder, and their boundaries are shifted.

Further, when, for example, shifts of boundaries reach a predetermined number of a plurality of lines per horizontal line of a liquid crystal panel, the boundaries return again to positions in the first display frame. Using this method makes it possible to uniformly distribute spots at which crosstalk occurs, in the entire display screen, and is effective for viewers to view stereoscopic image display of little crosstalk.

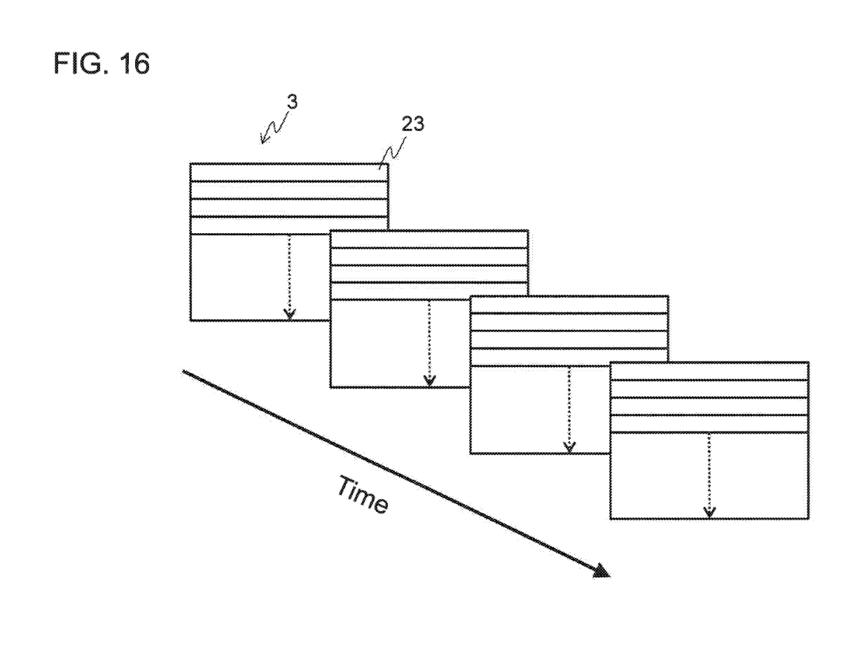

However, when the above liquid crystal display 3 is used in the stereoscopic image display apparatus 1, as illustrated in FIG. 16, information of a frame image is updated by sequentially overwriting and updating the screen from the horizontal line 23 at the top of the screen to the horizontal line 23 at the bottom. Therefore, the viewer occasionally views a previous image and the current new image at the same time. As a result, the stereoscopic image display apparatus 1 has a problem in which the viewer views with the left eye an image which needs to be viewed with the right eye, this frequently occurs, and the viewer 50 has difficulty in recognizing stereoscopic images. FIG. 16 is a view illustrating a display method of a conventional liquid crystal display.

In regard to this problem, with the first operation method example, the stereoscopic image display apparatus 1 according to the present embodiment can introduce a flashing operation of the backlight 2 to reduce the above-mentioned problem when information of the frame image is updated.

In the stereoscopic image display apparatus 1 according to the present embodiment as shown in FIG. 1, the controlling device 12 commands the liquid crystal display 3 to simultaneously output a right eye image and a left eye image on one frame image. When receiving this command the liquid crystal display 3 displays, for example, the right eye image and the left eye image respectively on the first image forming areas 21 and the second image forming areas 22 of the liquid crystal panel 6, as mentioned above. Simultaneously, the controlling device 12 controls the switching retarder 8 to control the phase difference states in the first polarizing areas 31 and the second polarizing areas 32 associated with the first image forming areas 21 and the second image forming areas 22.

Further, every time a frame is switched, the liquid crystal panel 6 and the switching retarder 8 are controlled to alternately replace image forming areas which display the right eye image and the left eye image, and display a frame image in which the right eye image and the left eye image are alternately arranged.

However, in order to prevent the above-mentioned problem, the controlling device 12 can perform control such that the liquid crystal display 3 simultaneously displays the right eye image and the left eye image on one frame image and then does not replace the image forming areas in the next frame. In this case, the controlling device 12 can control the liquid crystal display 3 to overwrite the images as is, to display the overwritten images in at least the next one frame period, and controls the switching retarder 8 to function according to the liquid crystal display 3.

Further, when image areas are replaced or overwritten in this way, the controlling device 12 can simultaneously control the lighting state of the backlight 2. That is, the backlight 2 is turned on in a period in which one frame image is displayed. In frames before and after the period, in which image forming areas which display the right eye image and the left eye image are replaced, it is possible to control the backlight 2 to turn off or decrease the brightness appropriately. By doing so, it is possible to prevent residual images of the right eye image and the left eye image and the above problem following replacement of image forming areas from being noticed by the viewer 50.

According to the above operation method, even when areas to form a right eye image and a left eye image are replaced at a predetermined cycle following switching of a frame, the viewer 50 can reliably view only right eye image light with the right eye and view only left eye image light with the left eye. Consequently, the viewer 50 can recognize these right eye image light and left eye image light as stereoscopic images at all times without sensing the above problem resulting from replacement of image areas.

In addition, in the case where a right eye image and a left eye image are simultaneously displayed on one frame image, and then the images are overwritten without replacing image areas in the next frame as described above, the number of times to switch images decreases. As a result, smoothness of display images is lost at a common frame frequency of 60 Hz in the liquid crystal display 3. Further, the backlight 2 is flashed at a cycle of 30 Hz per frame. Therefore, there is a concern that the viewer 50 notices this flashing of the backlight 2 via the resulting flicker.

Hence, it is preferable to increase the frame frequency in the liquid crystal display 3 to, for example, 120 Hz or more. By doing so, even when a right eye image and a left eye image are simultaneously displayed on one frame image and are overwritten as is without replacing image areas in the next frame, it is possible to form stereoscopic images matching the frame frequency of 60 Hz. As a result, the number of times to switch images increases and there is no concern that the viewer 50 notices flickers. Further, the above-mentioned flickers resulting from flashing of the backlight 2 are not noticed by the viewer 50. Consequently, the stereoscopic image display apparatus 1 according to the present embodiment provides natural display images.

In addition, in the stereoscopic image display apparatus 1 according to the present embodiment, it is possible to set the frame frequency to 240. Hz in the liquid crystal display 3 according to control by the controlling device 12. In this case, for example, a right eye image and a left eye image are simultaneously displayed on one frame image in the liquid crystal display 3, and are overwritten as is without replacing image areas in the next frame. Further, image areas are replaced in the subsequent frame, and then images are overwritten in the next frame. The controlling device 12 can perform control according to this pattern. That is, according to a pattern of repeating, replacing and overwriting display areas of a right eye image and a left eye image in the liquid crystal display 3 and overwriting the images per frame in this order, the controlling device 12 can control image formation.

When images are formed on the liquid crystal display 3 at such a cycle, a stereoscopic image matching the frame frequency of 120 Hz can be formed, and the number of times to switch images increases. As a result, there is no concern that the viewer notices flickers. Further, the backlight 2 is flashed at the cycle of 120 Hz. Consequently, there is no concern that the viewer 50 notices flickers.

Further, as another example, when the frame frequency is 240 Hz in the liquid crystal display 3, the controlling device 12 can perform control such that a right eye image and a left eye image are simultaneously displayed on one frame image by switching a frame, and then images are overwritten as is without replacing image areas in subsequent three frames. In this case, it is also possible to display the overwritten images on the liquid crystal display 3 in the next three frame periods and form stereoscopic images matching the frame frequency of 60 Hz.

In this case, the backlight 2 can be turned off for a 1/240 second, which is the first one frame period, and the backlight 2 can be turned on in 3/240 seconds, which are three frame periods in which the overwritten images are displayed. In this case, compared to the above pattern of repeating replacing display areas of a right eye image and a left eye image in the liquid crystal display 3 per frame and overwriting the images as is, the number of times to replace image areas decreases. However, it is possible to reduce the period in which the backlight is turned off according to the number of times of replacements. As a result, in the stereoscopic image display apparatus 1 it is possible to increase the brightness of stereoscopic images.

Further, in this case, the backlight 2 is flashed at the cycle of 60 Hz. Consequently, there is no concern that the viewer 50 notices flickers resulting from flashing of the backlight 2. As described above, by increasing the frame frequency of the liquid crystal display 3 to 120 Hz or 240 Hz, the viewer 50 can enjoy natural and high quality stereoscopic images.

Further, for the above problem, the stereoscopic image display apparatus 1 according to the present embodiment can reduce crosstalk resulting from an information update of a frame image while maintaining a high brightness without the flashing operation of the backlight 2. That is, with the second operation method example, in the liquid crystal display 3, when a frame image is switched, the screen is sequentially updated from the upper horizontal line to the lower horizontal line on the screen of the liquid crystal display 3. Further, in synchronization with this update, the phase difference states are switched from the upper side of the phase difference portion 33 to the lower side of the phase difference portion 33 in the switching retarder 8. By doing so, it is possible to prevent this problem.

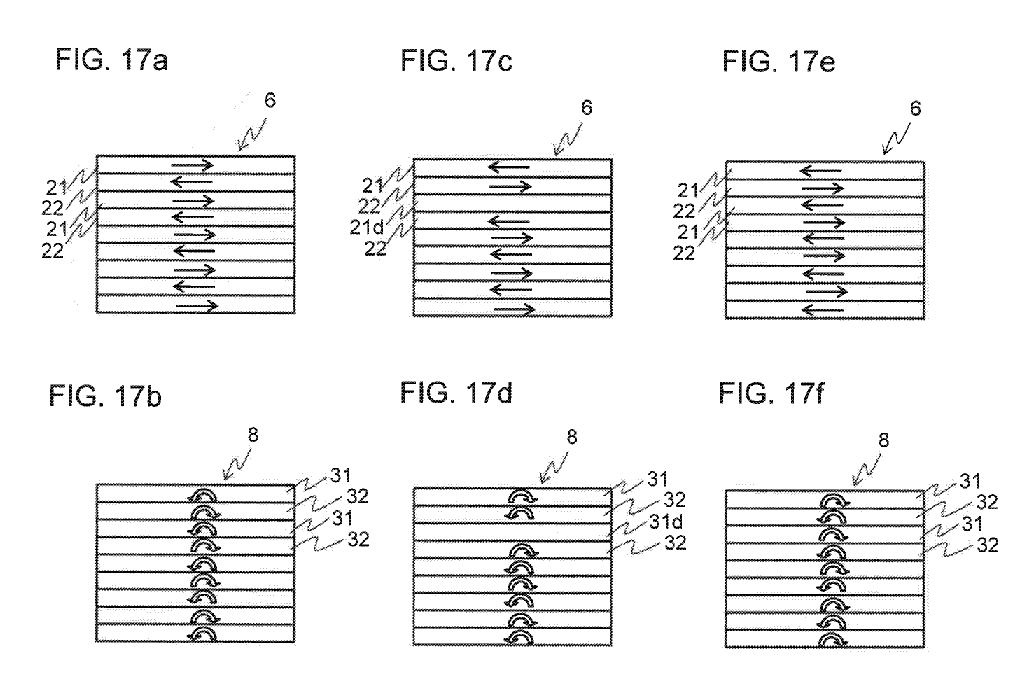

FIGS. 17(a) to 17(f) are views illustrating the second operation method of the stereoscopic image display apparatus 1 according to the present embodiment.

As described above, the controlling device 12 of the stereoscopic image display apparatus 1 according to the present embodiment illustrated in FIG. 1 commands the liquid crystal display 3 to simultaneously output a right eye image and a left eye image on one frame image. Further, when receiving this command, the liquid crystal display 3 forms, for example, the following image on the liquid crystal panel 6 forming the liquid crystal display 3. That is, as illustrated in FIG. 17(a), a right eye image and a left eye image are displayed on the first image forming areas 21 and the second image forming areas 22, respectively, which are each formed with a plurality of horizontal lines continuously aligned in the vertical direction and which are alternately arranged.

Further, at the same time, as illustrated in FIG. 17(b), the controlling device 12 controls the switching retarder 8, and selects and controls the phase difference states such that the left eye and the right eye of the viewer 50 can appropriately sense the right eye image and the left eye image per first polarizing area 31 and second polarizing area 32 associated with the first image forming areas 21 and the second image forming areas 22.

In addition, in FIG. 17(a), arrows are schematically shown in the first image forming areas 21 and the second image forming areas 22. The directions of these arrows serve to distinguish between a right eye image and a left eye image to be output. Hence, when a right eye image is output, a rightward arrow is shown and, when a left eye image is output, a leftward arrow is shown. The same applies to FIGS. 17(c) and 17(e).

Further, as described below, in a first image forming area 21a in which an arrow is not shown in FIG. 17(c), a right eye image and a left eye image are being switched in horizontal lines in this area. The same applies to FIG. 17(d) and, in a first polarizing area 31d associated with the first image forming area 21d, the phase difference state is being switched.

Further, the liquid crystal panel 6 and the switching retarder 8 are controlled following switching of a frame to alternately replace or overwrite image forming areas which display a right eye image and a left eye image, and display a frame image in which the right eye image and the left eye image are alternately arranged.

In this case, in the liquid crystal panel 6, when image forming areas, which display the right eye image, and the left eye image are alternately replaced, as illustrated in FIG. 17(c), the screen is sequentially updated from the upper horizontal line of the screen to the lower horizontal line of the screen. In FIG. 17(c), the first image forming area 21d is an area in which a right eye image and a left eye image are being switched in horizontal lines in this area.

In this case, the switching retarder 8 does not wait for the phase difference states to switch until the entire screen of the liquid crystal panel 6 is replaced according to control by the controlling device 12. As illustrated in FIG. 17(d), even in the switching retarder 8, it is possible to switch the phase difference state of the first polarizing areas 31 and the phase difference state of the second polarizing areas 32 in association. That is, by controlling a signal synchronized with a scan signal for forming an image in the liquid crystal panel 6, as illustrated in FIG. 17(d), following an update of the screen of the liquid crystal panel 6, the phase difference states of the corresponding first polarizing areas 31 and second polarizing areas 32 of the switching retarder 8 are switched.

Further, when, as illustrated in FIG. 17(e), updating of images of the entire screen of the liquid crystal panel 6 is finished, as illustrated in FIG. 17(f), switching of the phase difference states of the entire first polarizing areas 31 and second polarizing areas 32 of the switching retarder 8 is simultaneously finished.

By adopting the above operation method, even when areas for forming a right eye image and a left eye image are replaced at a predetermined cycle following switching of a frame, the viewer 50 can view only right eye image light with the right eye, and view only left eye image light with the left eye. Consequently, the viewer 50 does not sense the above crosstalk resulting from replacement of the image areas, and can recognize these right eye image light and left eye image light as stereoscopic images at all times. Further, the stereoscopic image display apparatus 1 does not need to turn off the backlight 2 even in a frame in which image forming areas which display a right eye image and a left eye image on the liquid crystal panel 6 are replaced. As a result, the stereoscopic image display apparatus 1 can display bright stereoscopic images

The present invention is not limited to the above-mentioned embodiments and may be utilized without departing from the spirit and scope of the present invention. For example, the present invention can reduce areas in which crosstalk occurs in the stereoscopic image display apparatus, and uniformly distribute the areas in the entire display screen. As a result, a view angle is increased, so that it is possible to view stereoscopic image display of little crosstalk from a wide range. Consequently, even when substrates which form a switching retarder and a liquid crystal display combined with the switching retarder become thick, it is possible to provide a stereoscopic image display apparatus which prevents occurrence of crosstalk and secures a sufficient view angle range.

Further, instead of a liquid crystal display formed with a liquid crystal panel, a plasma display panel (PDP) formed with a plasma panel can be used and combined with the above switching retarder which is an optical unit to form a stereoscopic image display apparatus. That is, the stereoscopic image display apparatus 1 according to the present embodiment illustrated in FIG. 1 can be formed using the PDP formed with the plasma panel and a polarizing plate arranged thereon instead of the liquid crystal display 3. In addition, in this case, the backlight 2 illustrated in FIG. 1 is not necessary.

Further, in the stereoscopic image display apparatus which uses the PDP, the PDP can also have the same first image forming areas and second image forming areas formed with a plurality of horizontal lines as those of the liquid crystal display 3. In the PDP, as well as the liquid crystal panel 6, displays a right eye image and a left eye image of one frame image to be displayed, on the first image forming areas 21 and the second image forming areas 22, respectively, and replaces the right eye image and the left eye image between the first image forming areas 21 and the second image forming areas 22 according to the following method of (1) or (2).

(1) switching the right eye image and the left eye image every time a frame is switched.

(2) when (1) is not the case replacing the right eye image and the left eye image and updating an image displayed in an immediate frame when the frame is switched, ((2) does not include the case wherein right eye image and left eye image is retained without replacement).

Further, when a right eye image and a left eye image are replaced, it is possible to move or keep boundaries between the first image forming areas and the second image forming areas and move these boundaries at a desired period. Consequently, by combining the PDP and the above switching retarder, the stereoscopic image display apparatus which uses the PDP can be formed as the same stereoscopic image display apparatus as the stereoscopic image display apparatus 1 which uses the liquid crystal display 3.

Thus, by using a PDP, which uses comparatively thick glass having, for example, 2 mm to 3 mm of thickness, it is possible to form the stereoscopic image display apparatus. That is, by combining the above switching retarder and the PDP, it is possible to form a stereoscopic image display apparatus which uses the PDP and which can respond at a high speed to high frequency driving.

### REFERENCE SIGNS LIST

1 Stereoscopic image display apparatus
2 Backlight
3 Liquid crystal display
5,7,45 a, 45b Polarizing plate
6 Liquid Crystal Panel
8 Switching retarder
10 Polarized glasses
12 Controlling device
21, 21a, 21b, 21c, 21d First image forming areas
22, 22a, 22b, 22c Second image forming areas
23 Horizontal line
25, 25a, 25b, 25c, 35, 35a, 35b, 35c Boundaries
31, 31a, 31b, 31c, 31d First polarizing areas
32, 32a, 32b, 32c Second polarizing areas
33 Phase difference portions
41 Right eye glass
42 Left eye glass
43a, 43b ¼ wave plates
50 Viewer
101 Adhesive
104,105,114,115 Substrate
106, 116 Liquid Crystal
117 and 118 Oriented film
119, 120 Transparent electrode
121 Phase difference film
201,202,203,206,207,208,211,212,213,216,217,218,221,222,223,226,227,228 Linearly polarized light
204,205,209,210,214,215,219,220,224,225,229,230
Circularly polarized light
300 passive driven liquid crystal display element
301 Lower electrodes
302 Upper electrodes
310 Active driven liquid crystal display element
311, 321 signal line
312, 320 scan lines
313, 323 active elements
314 Pixel electrodes

1. A stereoscopic image display apparatus comprising:
a liquid crystal display which includes a liquid crystal panel comprising, arranged in a vertical direction, horizontal rows of aligning pixels, and a pair of polarizing plates which sandwich the liquid crystal panel;
a backlight located on a back side of the liquid crystal display;
an optical unit located on a front side of the liquid crystal display;
polarizing eyeglasses worn by a viewer in viewing images on the liquid crystal display; and
a control device which controls image display of the liquid crystal display and phase difference state of the optical unit, wherein
the liquid crystal display includes, alternately arranged first image forming areas and second image forming areas including pluralities of continuously arranged horizontal rows of the liquid crystal panel, and controlled by the control device such that, simultaneously, the first image forming areas display one of a right eye image and a left eye image, and the second image forming areas display the other of the right eye image and the left eye image,
the first image forming areas and the second image forming areas perform one of:
(1) replacing the right eye image and the left eye image every time a frame is switched or,
(2) replacing the right eye image and the left eye image and updating an image displayed in an immediately preceding frame when the frame is switched,
when the right eye image and the left eye image are replaced, a boundary between the first image forming areas and the second image forming areas is moved or maintained, for moving of the boundary at a desired timing,
the optical unit includes a plurality of phase difference portions corresponding to each of the horizontal rows of the liquid crystal panel, and
a first polarizing area and a second polarizing area including bundles of the phase difference portions are arranged in ranges corresponding to the first image forming areas and the second image forming areas, and include different phase difference states which are controlled by the control device in synchronization with the timing of replacement of the right eye image and the left eye image.

2. The stereoscopic image display apparatus according to claim 1, wherein the first image forming areas and the second image forming areas comprise the same area, both before and after movement of the boundaries, except uppermost and lowermost first image forming areas and uppermost and lowermost second image forming areas of the liquid crystal display.

3. The stereoscopic image display apparatus according to claim 1, wherein the timing for moving the boundaries between the first image forming areas and the second image forming areas is one of (i) the time when the right eye image is replaced by the left eye image, or (ii) the time when the left eye image is replaced by the right eye image in the first image forming areas.

4. The stereoscopic image display apparatus according to claim 1, wherein, following movement of the boundary between the first image forming areas and the second image forming areas, a boundary between the first polarizing area and the second polarizing area of the optical unit moves.

5. The stereoscopic image display apparatus according to claim 1, wherein the boundary between the first image forming areas and the second image forming areas is moved by each one of the horizontal rows.

6. The stereoscopic image display apparatus according to claim 1, wherein each of the first image forming areas and the second image forming areas is an image forming area including two to sixty horizontal rows continuously arranged in the vertical direction of the liquid crystal panel.

7. The stereoscopic image display apparatus according to claim 1, wherein,
in the optical unit, according to control by the controlling device, the first polarizing area and the second polarizing area comprise respectively different phase difference states,
the different phase difference states are replaced between the first polarizing area and the second polarizing area in synchronization with replacing the right eye image and the left eye image on the liquid crystal display.

8. The stereoscopic image display apparatus according to claim 1, wherein the controller controls all of the lighting state of the backlight according to a timing of replacement of the right eye image and the left eye image.

9. The stereoscopic image display apparatus according to claim 1, wherein the control device
sequentially controls the horizontal rows from an uppermost horizontal row to a lowermost horizontal row of the liquid crystal display, thereby controlling replacement of the right eye image and the left eye image in the first image forming areas and the second image forming areas, and
sequentially controls the phase difference portions from an uppermost phase difference portion to a lowermost phase difference portion of the optical unit, in synchronization with control of the liquid crystal display, thereby controlling the phase difference states of the first polarizing area and the second polarizing area.

10. The stereoscopic image display apparatus according to claim 1, wherein the optical unit sandwiches a liquid crystal material between a pair of substrates comprising opposing surfaces on which transparent electrodes are disposed, and comprises phase difference films on outer surfaces of the substrates which sandwich the liquid crystal material.

11. The stereoscopic image display apparatus according to claim 1, wherein the optical unit includes one liquid crystal element selected from the group consisting of a TN liquid crystal element, a homogeneous liquid crystal element, and a ferroelectric liquid crystal element.

12. The stereoscopic image display apparatus according to claim 1, including a substrate of the optical unit wherein the substrate is a film selected from the group consisting of a polycarbonate film, a triacetylcellulose film, a cycloolefin polymer film, a polyether sulfone film, and a glass cloth reinforced transparent film.

13. The stereoscopic image display apparatus according to claim 1, wherein the liquid crystal display switches frames at a rate of at least 120 Hz.

14. The stereoscopic image display apparatus according to claim 13, wherein the liquid crystal display switches frames at a cycle of at least 240 Hz.

15. A stereoscopic image display apparatus comprising:
a plasma display which includes a plasma panel comprising, arranged in a vertical direction, horizontal rows of aligning pixels, and a polarizing plate located on the plasma panel;
an optical unit located on a front side of the plasma display;
polarizing eyeglasses worn by a viewer in viewing images on the plasma display; and
a control device which controls image display of the plasma display and phase difference state of the optical unit, wherein
the plasma display includes alternately arranged, first image forming areas and second image forming areas including a plurality of continuously arranged horizontal rows of the plasma panel, and controlled by the control device such that, simultaneously, the first image forming areas display one of a right eye image and a left eye image, and the second image forming areas display the other image of the right eye image and the left eye image,
the first image forming areas and the second image forming areas perform one of:
(1) switching the right eye image and the left eye image every time a frame is switched,
(2) replacing the right eye image and the left eye image and updating an image displayed in an immediately preceding frame when the frame is switched,
when the right eye image and the left eye image are replaced, a boundary between the first image forming areas and the second image forming areas is moved or maintained for moving the boundary at a desired timing,
the optical unit includes a plurality of phase difference portions corresponding to each of the horizontal rows of the plasma panel, and
a first polarizing area and a second polarizing area including bundles of the phase difference portions are arranged in ranges corresponding to the first image forming areas and the second image forming areas, and include different phase difference states which are controlled by the control device in synchronization with the timing of replacement of the right eye image and the left eye image.
